(19) United States
(12) Patent Application Publication
(10) Pub. No.: US 2007/0233828 A1
(43) Pub. Date: Oct. 4, 2007

(54) METHODS AND SYSTEMS FOR PROVIDING DATA STORAGE AND RETRIEVAL

(76) Inventor: Jeremy Gilbert, Cambridge, MA (US)

Correspondence Address: CHOATE, HALL & STEWART LLP, TWO INTERNATIONAL PLACE, BOSTON, MA, 02110, US

(21) Appl. No.: 11/278,305

(22) Filed: Mar. 31, 2006

(51) Int. Cl. G06F 15/173

(52) U.S. Cl. 709/223

(57) ABSTRACT

In a method of providing data storage and retrieval an asset stored by a first resource is identified. An asset record identifying the asset is generated. At least one of the following is transmitted to an agent associated with a second resource: the generated asset record, metadata associated with the asset, a description of a condition associated with the asset, the generated asset record and metadata associated with the asset, the generated asset record and a description of a condition associated with the asset, the asset and metadata associated with the asset, the asset and a description of a condition associated with the asset, metadata and a description of a condition associated with the asset, the generated asset record and the asset and a description of a condition associated with the asset, and the generated asset record and the asset and metadata associated with the asset.

### FIELD OF THE INVENTION

The invention relates to methods and systems for providing data storage and retrieval, and, in particular, to methods and systems for providing data storage and retrieval over a network.

### BACKGROUND OF THE INVENTION

Conventional systems exist for making a back-up copy of a file or for sending a file to be archived to specifically designated server over a network. Existing technologies like the “rsync” Unix command and the proprietary engines behind popular enterprise and on-line data backup/archival tools have established how to handle this process of moving data from sources to an established population of target servers and sites.

Many of these systems, however, lack the ability to manage a changing data archiving relationship over time. For example, these systems typically lack systems for automatically ensuring that a set of files on one machine consistently remain on a second machine. Typically, these technologies do not handle well situations where the source and target constantly change, where varying levels of trust exist between the source and the target machines, or where the data may migrate to different target servers or sites over time. Conventional data archiving technologies are typically intended to statically maintain a set of target data on a series of storage resources over a long period of time.

Additionally, conventional systems were designed around the principle that the permanent hardware storage mechanism used to preserve the data on target sites must be made as reliable as possible in order to guarantee system-wide reliability. In assuming that failure events on the target backup media are relatively rare events, these solutions are poor at handling cases where the target backup media fails, requiring “out of band” operator intervention. For instance, if a server is backing up to a replicated disk in a second data center, and the replicated disk fails, typically the operator must intervene to select a new disk, or repair that disk and re-establish the transfer. Alternatively, conventional systems must rely upon redundant hardware systems to maintain overall reliability, increasing the cost of the solution.

Furthermore, typical data backup and archival solutions are strongly centered around relatively well-defined rules that govern which targets receive information from sources. For example, typical solutions do not easily handle rules requiring maintenance of multiple copies of data from a particular source amongst varying servers or requiring copying information from a particular source to a particular target server chosen based on date, time, or other variables. Once information from the source has been moved to a target server, it typically stays on the target server, without the ability to move the data later to a different target server. In most traditional models this type of information spreading during and after the data transfer would not be considered desirable because with protected data spread out over so many different places, a data catalog would be needed to manage these events and allow the data to be subsequently retrieved.

When enterprises seek to store information redundantly, they are typically forced to eschew software data backup or archival solutions and instead must purchase expensive SAN hardware which inflates the cost of data storage by 10-100× but provides a much lower management overhead for the operator. While SAN allows for fast access to redundant on-line storage, it is not designed for, or cost-effective for situations which do not require instantaneous access to archived or stored data.

### SUMMARY OF THE INVENTION

In some embodiments, the methods and apparatus described provide solutions for data storage and retrieval via sophisticated data logistics management. In one of these embodiments, the methods described provide a number of additional dimensions of flexibility and accountability, support varying levels of trust among software agents supporting the data storage, are amenable to novel organizations of software agents, and provide resiliency guarantees without the need for the underlying data storage or server hardware to itself be redundant. In another of these embodiments, the methods and apparatus described include a software-based logistical organizer for data storage and transfer. Through the naming of data to be tracked and the creation of a distributed database maintaining the storage location of the tracked data, the methods and systems described provide a wide range of data storage and retrieval solutions.

The methods and systems described provide data storage and retrieval solutions. In some embodiments, the methods use flexibly-defined software agents storing and retrieving data. In one of these embodiments, varying levels of trust are established between data preservation agents. In other embodiments, reliability guarantees are provided without the need for the underlying data storage or server hardware to itself be redundant. In still other embodiments, a “data naming service” allowing for globally universal or site-wide universal naming of data assets. In yet other embodiments, the methods and systems provide data storage and retrieval functionality with the ability to move and track stored data over time, centered around lowest common denominator hardware.

In one aspect, a method of providing data storage and retrieval includes the step of identifying an asset stored by a first resource. An asset record identifying the asset is generated. At least one of the following is transmitted to an agent associated with a second resource: the generated asset record, metadata associated with the asset, a description of a condition associated with the asset, the generated asset record and metadata associated with the asset, the generated asset record and a description of a condition associated with the asset, the asset and metadata associated with the asset, the asset and a description of a condition associated with the asset, metadata and a description of a condition associated with the asset, the generated asset record and the asset and a description of a condition associated with the asset, and the generated asset record and the asset and metadata associated with the asset.

In one embodiment, the second resource is identified responsive to a rule. In another embodiment, the information is transmitted to an agent associated with a proxy. In still another embodiment, a condition associated with the asset is satisfied.

In another aspect, a system for providing data storage and retrieval comprises a means for identifying an asset stored by a first resource, a means for generating an asset record identifying the asset, and a means for transmitting, to an agent associated with a second resource, at least one of: an asset record identifying an asset, metadata associated with the asset, a description of a condition associated with the asset, the asset record and metadata associated with the asset, the asset record and a description of a condition associated with an asset, the asset and metadata associated with the asset, the asset and a description of a condition associated with the asset, metadata and a description of a condition associated with the asset, the asset record and the asset and a description of a condition associated with the asset, and the asset record and the asset and metadata associated with the asset.

In still another aspect, a method of providing data storage and retrieval includes the step of receiving at least one of the following from an agent associated with a resource: an asset record identifying an asset, metadata associated with the asset, a description of a condition associated with the asset, the asset record and metadata associated with the asset, the asset record and a description of a condition associated with the asset, the asset and metadata associated with the asset, the asset and a description of a condition associated with the asset, metadata and a description of a condition associated with the asset, the asset record and the asset and a description of a condition associated with the asset, and the asset record and the asset and metadata associated with the asset. A determination is made to satisfy a condition associated with the asset.

In one embodiment, a description of the condition associated with the asset is received from a second agent. In another embodiment, a determination is made not to satisfy a condition associated with the asset. In still another embodiment, a data structure is generated, the data structure identifying the asset, identifying a local resource, indicating whether the asset resides on the second resource, and, optionally, identifying a condition associated with the asset.

In yet another aspect, a system for providing data storage and retrieval comprises a means for receiving, from an agent associated with a resource, at least one of: an asset record identifying an asset, metadata associated with the asset, a description of a condition associated with the asset, the asset record and metadata associated with the asset, the asset record and a description of a condition associated with the asset, the asset and metadata associated with the asset, the asset and a description of a condition associated with the asset, metadata and a description of a condition associated with the asset, the asset record and the asset and a description of a condition associated with the asset, and the asset record and the asset and metadata associated with the asset; and the system comprises a means for determining to satisfy a condition associated with the asset.

In one aspect, a method of providing data storage and retrieval includes the step of accessing a data structure, the data structure identifying an asset, identifying a resource associated with the asset, indicating that the asset does not reside on the resource, and identifying a condition associated with the asset, the condition comprising one oft a condition requiring maintenance of a copy of the asset on a second resource; a condition requiring transmission of a copy of the asset to a second resource; a condition requiring maintenance of a copy of the data structure on the resource; a condition requiring maintenance of a copy of the data structure on a second resource; a condition requiring transmission of a copy of the data structure to a second resource; a condition requiring deletion of a copy of the asset; a condition requiring verification of the data structure associated with the asset; a condition requiring maintenance of an identification of a resource on which the asset resides; and a condition requiring verification of a copy of the asset on a second resource. At least one rule associated with the asset is consulted. A condition associated with the asset is satisfied. In one embodiment, the condition is identified by at least one rule. In another embodiment, a determination is made not to satisfy the condition.

In another aspect, a system for providing data storage and retrieval comprises a means for accessing a data structure identifying an asset, identifying a resource associated with the asset, indicating that the asset does not reside on the resource, and identifying a condition associated with the asset, the condition comprising one of a condition requiring maintenance of a copy of the asset on a second resource; a condition requiring transmission of a copy of the asset to a second resource; a condition requiring maintenance of a copy of the data structure on the resource; a condition requiring maintenance of a copy of the data structure on a second resource; a condition requiring transmission of a copy of the data structure to a second resource; a condition requiring deletion of a copy of the asset; a condition requiring verification of the data structure associated with the asset; a condition requiring maintenance of an identification of a resource on which the asset resides; and a condition requiring verification of a copy of the asset on a second resource; and the system comprises a means for consulting at least one rule associated with the asset and a means for satisfying the condition.

In still another aspect, a method of providing data storage and retrieval includes the step of accessing a data structure, the data structure identifying an asset, identifying a resource associated with the asset, indicating that the asset resides on the resource, and identifying a condition associated with the asset. At least one rule associated with the asset is consulted. A condition associated with the asset is satisfied. In one embodiment, the condition is identified by at least one rule. In another embodiment, a determination is made not to satisfy the condition.

In yet another aspect, a system for providing data storage and retrieval comprises a means for accessing a data structure identifying an asset, identifying a resource associated with the asset, indicating that the asset resides on the resource, and identifying a condition associated with the asset; a means for consulting at least one rule associated with the asset; and a means for satisfying the condition.

In one aspect, a method of providing data storage and retrieval includes the step of receiving at least one of the following from an agent associated with a first resource: an asset record identifying an asset, metadata associated with the asset, the description of a condition associated with the asset, the asset record and metadata associated with the asset, the asset record and a description of a condition associated with the asset, the asset and metadata associated with the asset, the asset and a description of a condition associated with the asset, metadata and a description of a condition associated with the asset, the asset record and the asset and a description of a condition associated with the asset, and the asset record and the asset and metadata associated with the asset. A determination is made to satisfy a condition associated with the asset. A data structure is transmitted, the data structure identifying the asset, identifying a second resource, and indicating whether the asset resides on the second resource. In one embodiment, a condition associated with the asset is identified by the data structure. In another embodiment, an agent generates the data structure. In still another embodiment, metadata is transmitted with the data structure.

In another aspect, a system for providing data storage and retrieval comprises a means for receiving, from an agent associated with a first resource, at least one of: an asset record identifying an asset, metadata associated with the asset, the description of a condition associated with the asset, the asset record and metadata associated with the asset, the asset record and a description of a condition associated with the asset, the asset and metadata associated with the asset, the asset and a description of a condition associated with the asset, metadata and a description of a condition associated with the asset, the asset record and the asset and a description of a condition associated with the asset, and the asset record and the asset and metadata associated with the asset; a means for determining to satisfy a condition associated with the asset; and a means for transmitting a data structure, the data structure: identifying the asset, identifying a second resource, and indicating whether the asset resides on a second resource.

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1A is a block diagram depicting one embodiment of a system for providing data storage and retrieval;

FIG. 1B and FIG. 1C are block diagrams depicting one embodiment of a computer system useful in a system for providing data storage and retrieval;

FIG. 2 is a flow diagram depicting one embodiment of the steps taken in a method for providing data storage and retrieval in which an asset is identified and information associated with the asset is transmitted;

FIG. 3 is a flow diagram depicting one embodiment of the steps taken in a method of providing data storage and retrieval in which a determination is made to satisfy a condition associated with an asset;

FIG. 4 is a block diagram depicting one embodiment of a system in which software agents provide data backup services over a network;

FIG. 5 is a block diagram depicting one embodiment of a system of resources storing data structures identifying information associated with assets;

FIG. 6 is a flow diagram depicting one embodiment of the steps taken in a method for providing data storage and retrieval in which a data structure storing information associated with an asset is accessed;

FIG. 7 is a flow diagram depicting one embodiment of the steps taken in a method for providing data storage and retrieval in which a data structure storing information associated with an asset is accessed;

FIG. 8 is a flow diagram depicting one embodiment of the steps taken in a method for providing data storage and retrieval; and

FIG. 9 is a block diagram depicting one embodiment of a system in which software agents provide data backup services over a network.

### DETAILED DESCRIPTION OF THE INVENTION

In some embodiments, a data management architecture maintains redundant backup archives of a large volume of information (such as files or databases) across a distributed network of servers and other agents capable of storing information. In one embodiment, a method records where redundant copies of data have been stored in a specialized, highly distributed and self-organizing tracking database. In another embodiment, a method includes maintaining, by a system of agents, certain guarantees about the number of redundant copies and their geographic locations In still another embodiment, a method eliminates the need for specialized hardware redundancy system (such as RAID 5/10) and instead pushes the burden of replication and overall system resiliency into the design and behavior of management software. This method encourages the use of inexpensive, commodity-level hardware to hold the backup copies of information, allowing a solution's operational cost to approach the commodity price-per-gigabyte of unmanaged hard drive storage. This approach runs contrary to prevailing industry wisdom that “managed” or “smart” storage is required for operational redundancy at this scale. In one embodiment, a method provides a general platform for accounting for information storage and transfer among multiple nodes with varying levels of trust and can be configured in many different ways based on the target application.

In another embodiment, the methods described are amenable to both strongly centralized and strongly decentralized data backup, archival and storage applications. In some embodiments, a method provides a general service for personal computers and servers to be backed up to an off-site repository by transmitting encrypted data over Internet connections. The method implemented would largely be invisible to the end-customer and would primarily facilitate efficiency within the service provider.

In another embodiment, a method provides a strongly distributed, decentralized model where federated sites or individuals reciprocally offer to hold copies of data from other sites. The architecture facilitates the cooperation between those customers in holding redundant copies of their data in a manageable and cost-effective manner.

In still another embodiment, a method provides a backbone technology for various vertical data storage applications that seek to eliminate the use of expensive storage area networks. For example, photo sharing services, medical imaging applications, and other specific industries manage large sets of files and currently rely on expensive storage area management hardware and software solutions. These verticals may potentially leverage the methods described to provide a more cost-effective means of storing and managing their information, subject to certain trade-offs, such as a potentially slower access time. In another example, a method enables the delegation of data storage from these vertical data storage applications to other entities provided by the method, as in a franchising model.

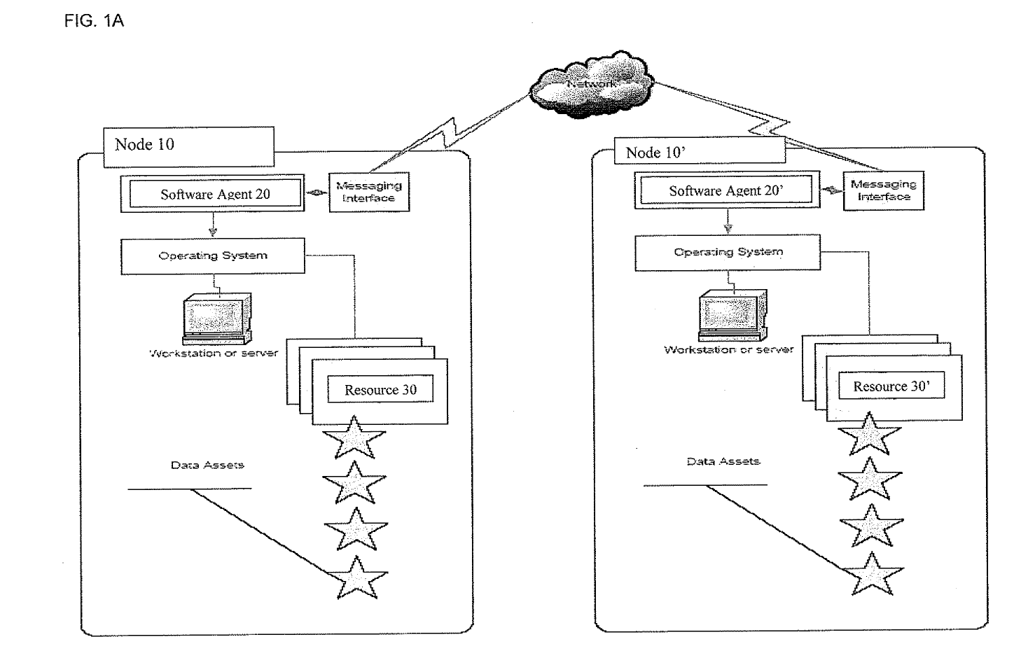

Referring now to FIG. 1A, a block diagram depicts one embodiment of a system for providing data storage and retrieval including a means for identifying an asset stored by a first resource, a means for generating an asset record identifying the asset, and a means for transmitting, to an agent associated with a second resource, at least one of: (i) an asset record identifying an asset, (ii) metadata associated with the asset, (iii) a description of a condition associated with the asset, (iv) the asset record and metadata associated with the asset, (v) the asset record and a description of a condition associated with the asset, (vi) the asset and metadata associated with the asset, (vii) the asset and a description of a condition associated with the asset, (viii) metadata and a description of a condition associated with the asset, (ix) the asset record and the asset and a description of a condition associated with the asset, and (x) the asset record and the asset and metadata associated with the asset.

In one embodiment, the system enables organization of a large amount of information in a large “virtual” file system that may serve multiple customers or businesses. There are a variety of internal components that serve to create a large, self-organized virtual database of file pointers, including, but not limited to, nodes, resource, software agents, asset records, receipts and meta-information.

In some embodiments, software agents 20, nodes 10, and resources 30 collaborate in a messaging network to organize the transmission, receipt, storage and verification of data assets. In one of these embodiments, a machine that either protects or provides information is thought of as a “node” in a mesh of computers. Each node 10 may provide one or more resources containing files or other information. In another of these embodiments, a resource 30 may comprise a hard drive, or a partition on a hard drive. Each data element on the disk, which could be a user-visible file (such as a word processing document) or a copy of data residing on a different resource 30 or node 10 (such as a word processing document residing on a resource 30′ on a node 10′) may be referred to as a data asset. In still another of these embodiments, the system includes a uniform and generalized mechanism for assets, and copies of assets to be managed over multiple machines.

In some embodiments, one or more nodes on a network are identified. In one of these embodiments, each node may be logically or physically segregated from other nodes. In another of these embodiments, each physical device (such as a client computer to be backed up) will be a unique node. In still another of these embodiments, a single physical machine may host multiple nodes. In yet another embodiment, a node could be entity, logical or physical, that shows a single system image, therefore a cluster of machines could be virtualized into a single node.

In one embodiment, depicted in FIG. 1A, a software agent 20 provides a means for identifying an asset stored by a first resource 30. In another embodiment, a software agent 20 provides a means for identifying a block of information on a node 10. In still another embodiment, the first resource 30 resides on a node 10.

In some embodiments, the system includes a means for identifying at least one resource in a plurality of resources. In one of these embodiments, the plurality of resources resides on a single node 10. In another of these embodiments, the plurality of resources resides in distributed locations across multiple nodes 10, 10′. In still another of these embodiments embodiments, the system include a means for consulting at least one rule when identifying the at least one resource in the plurality of resources.

In other embodiments, the system includes a means for determining whether a copy of an asset resides on a resource in a plurality of resources. In one of these embodiments, a software agent 20 identifies an asset in a resource 30 on a node 10. In another of these embodiments, a software agent 20 determines whether a copy of the identified asset resides in a resource 30′ on a node 10′. In still another of these embodiments, a software agent 20 includes a means for identifying at least one resource in a plurality of resources. In still another of these embodiments, the system includes a means for consulting at least one receipt when determining whether a resource in the plurality of resources copy of the identified asset. In some embodiments, the system includes a means for satisfying a condition associated with the asset.

FIGS. 1B and 1C depict block diagrams of a typical computer system useful in some embodiments as a node 10. As shown in FIGS. 1B and 1C, each node 10 includes a central processing unit 102, and a main memory unit 104. Each node 10 may also include other optional elements, such as one or more input/output devices 130a-130n (generally referred to using reference numeral 130), and a cache memory 140 in communication with the central processing unit 102.

The central processing unit 102 is any logic circuitry that responds to and processes instructions fetched from the main memory unit 104. In many embodiments, the central processing unit is provided by a microprocessor unit, such as those manufactured by Intel Corporation of Mountain View, Calif.; those manufactured by Motorola Corporation of Schaumburg, Ill.; those manufactured by International Business Machines of White Plains, N.Y.; or those manufactured by Advanced Micro Devices of Sunnyvale, Calif.

Main memory unit 104 may be one or more memory chips capable of storing data and allowing any storage location to be directly accessed by the microprocessor 102, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM(FRAM).

In the embodiment shown in FIG. 1B, the processor 102 communicates with main memory 104 via a system bus 120 (described in more detail below). FIG. 1C depicts an embodiment of a node 10 in which the processor communicates directly with main memory 104 via a memory port. For example, in FIG. 1C, the main memory 104 may be DRDRAM.

FIG. 1B and FIG. 1C depict embodiments in which the main processor 102 communicates directly with cache memory 140 via a secondary bus, sometimes referred to as a “backside” bus. In other embodiments, the main processor 102 communicates with cache memory 140 using the system bus 120. Cache memory 140 typically has a faster response time than main memory 104 and is typically provided by SRAM, BSRAM, or EDRAM.

In the embodiment shown in FIG. 1B, the processor 102 communicates with various I/O devices 130 via a local system bus 120. Various busses may be used to connect the central processing unit 102 to the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display, the processor 102 may use an Advanced Graphics Port (AGP) to communicate with the display. FIG. 1C depicts an embodiment of a node 10 in which the main processor 102 communicates directly with I/O device 130b via HyperTransport, Rapid I/O, or InfiniBand. FIG. 1C also depicts an embodiment in which local busses and direct communication are mixed: the processor 102 communicates with I/O device 130a using a local interconnect bus while communicating with I/O device 130b directly.

A wide variety of I/O devices 130 may be present in the node 10. Input devices include keyboards, mice, trackpads, trackballs, microphones, and drawing tablets. Output devices include video displays, speakers, inkjet printers, laser printers, and dye-sublimation printers. An I/O device may also provide mass storage for the node 10 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif., and the iPod Shuffle line of devices manufactured by Apple Computer, Inc., of Cupertino, Calif.

In further embodiments, an I/O device 130 may be a bridge between the system bus 120 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIG. 1B and FIG. 1C typically operate under the control of operating systems, which control scheduling of tasks and access to system resources. Typical operating systems include: MICROSOFT WINDOWS, manufactured by Microsoft Corp. of Redmond, Wash. ; MacOS, manufactured by Apple Computer of Cupertino, Calif. ; OS/2, manufactured by International Business Machines of Armonk, N.Y. ; and Linux, a freely-available operating system distributed by Caldera Corp. of Salt Lake City, Utah, among others.

The node 10 may be any personal computer (e.g., a Macintosh computer or a computer based on processors such as 286, 386, 486, Pentium, Pentium II, Pentium III, Pentium IV, Pentium M, the Celeron, or the Xeon processor, all of which are manufactured by Intel Corporation of Mountain View, Calif.), Windows-based terminal, Network Computer, wireless device, information appliance, RISC Power PC, X-device, workstation, mini computer, main frame computer, personal digital assistant, or other computing device that has a windows-based desktop. Windows-oriented platforms supported by the node 10 can include, without limitation, WINDOWS 3.x, WINDOWS 95, WINDOWS 98, WINDOWS NT 3.51, WINDOWS NT 4.0, WINDOWS 2000, Windows 2003, WINDOWS CE, Windows XP, Windows vista, MAC/OS, Java, Linux, and UNIX. In some embodiments, the node 10 can include a visual display device (e.g., a computer monitor), a data entry device (e.g., a keyboard), persistent or volatile storage (e.g., computer memory) for storing downloaded application programs, a processor, and a mouse. In other embodiments, the node 10 is a back-end server or mainframe and operates without a keyboard, mouse, display or windowing system.

For embodiments in which a node 10 is a mobile device, the device may be a JAVA-enabled cellular telephone, such as those manufactured by Motorola Corp. of Schaumburg, Ill., those manufactured by Kyocera of Kyoto, Japan, or those manufactured by Samsung Electronics Co., Ltd., of Seoul, Korea. In other embodiments in which the node 10 is mobile, it may be a personal digital assistant (PDA) operating under control of the PalmOS operating system, such as the devices manufactured by palmOne, Inc. of Milpitas, Calif. In further embodiments, the node 10 may be a personal digital assistant (PDA) operating under control of the PocketPC operating system, such as the iPAQ devices manufactured by Hewlett-Packard Corporation of Palo Alto, Calif., the devices manufactured by ViewSonic of Walnut, Calif., or the devices manufactured by Toshiba America, Inc. of New York, N.Y. In still other embodiments, the node 10 is a combination PDA/telephone device such as the Treo devices manufactured by palmOne, Inc. of Milpitas, Calif. In still further embodiments, the node 10 is a cellular telephone that operates under control of the PocketPC operating system, such as those manufactured by Motorola Corp.

In one embodiment, the node 10 communicates directly with another node 10′. In some embodiments the node 10 communicates with the node 10′ through a communications link 150. The communications link 150 may be synchronous or asynchronous and may be a LAN connection, MAN (Medium-area Network) connection, or a WAN connection. Additionally, communications link 150 may be a wireless link, such as an infrared channel or satellite band.

The communications link 150 may provide communications functionality through a variety of connections including standard telephone lines, LAN or WAN links (e.g., T1, T3, 56 kb, X.25, SNA, DECNET), broadband connections (ISDN, Frame Relay, ATM, Gigabit Ethernet, Ethernet-over-SONET), and wireless connections or any combination thereof. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the remote machine 30 and the client machine 10 communicate via any type and/or form of gateway or tunneling protocol such as Secure Socket Layer (SSL) or Transport Layer Security (TLS).

In some embodiments, a node 10 may discover other nodes in the network through a central, distributed or self-organized registry. Each node 10 may pass messages from one to another either directly, or using other nodes as routers. Each message may be unicast or multi-cast, reliable or unreliable. Messages may be inherently one way, that is, if a response is expected, the sender does not have to wait for the response. However, as an optimization for efficiency, it is certainly possible for the sender to wait for a response, possibly on a dedicated channel. In one embodiment, messages received in their entirety will be considered valid messages—the system assumes that if a message is received at all, the entire payload is uncorrupted.

Referring still to FIG. 1A, a resource 30 may refer to a data storage area. A resource could be a partition on a hard drive, an entire hard drive, a single tape drive or CD-ROM, a file system or part of a file system, or a single file, or any attached file system or accessible device, including network attached storage, SAN, mounted file server, or other service (local or network) established on the computer capable of performing I/O operations. Each resource 30 may have a presence on zero or more nodes. For example, a file system may be remotely mounted on one or more nodes 10. In one embodiment, whether a resource 30 exists on a node, and on which node 10 the resource exists, is published and known to other nodes 10′ either through a distributed system or through a central registration. In some embodiments, a resource 30 is assigned a unique name. In other embodiments, a resource 30 is a common hard drive and the operating system's file-based API is used to access the physical media.

In one embodiment, a resource is a place where information to be protected is stored, discovered or temporarily held. In another embodiment, a resource may be a user-visible file system or a user-hidden file system (each based on a host operating system's file system implementation) or potentially a private file system mapped by the resource's own logic to a block device such as a single file on a host operating system, a partition, or other non-structured storage element. (In the latter case, only the resource's agent itself is able to parse that block.) In still another embodiment, a resource allows for the storage of both atoms (meta-information) and actual assets. In yet another embodiment, a resource may fulfill a role without providing local data storage. The resource may fulfill requests and take actions responsive to the role without providing storage or discovery of protected information.

In some embodiments, resources may be identified as having a presence on a node. In one of these embodiments, identifying a resource as having a presence on a node indicates that services can be performed by that node on assets or atoms (such as send/receive/verify, etc.). In another of these embodiments, a resource may be identified as having a presence on multiple nodes.

A resource 30 may store one or more assets. In some embodiments, an asset is a block of information that may need to be transferred or protected. For example, an email message or a file on a hard drive at a particular point in time could be identified as an asset. In one of these embodiments, an asset is a stream of ordered bytes. In another of these embodiments, a record is maintained in a large distributed database about each asset. In still another of these embodiments, each asset is given its own system-wide unique identification number. In yet another of these embodiments, for each stream of bytes to be protected, there is an asset record that describes that stream of bytes, indicating how long it is, and also providing its checksum. This asset record may be stored in a managed database where it can be published to nodes and resources. For instance, an asset could represent the string of bytes in “my letter .doc.” Any node 10 storing a copy of asset record for the asset can reconstruct the contents of that file.

In some embodiments, the system includes objects referred to as atoms. In these embodiments, an atom is an object with certain fields and with values for those fields. In still another embodiment, an atom may exist in one or more locations on a network. In yet another embodiment, an atom represents a small fact about the overall system.

In one embodiment, an atom may be exchanged by nodes, resources, or software agents. In another embodiment, each type of atom has a uniqueness trait, which forms a primary key identifying the atom. In still another embodiment, an atom moves from one database to another database that already has an atom with that ID, a reconciliation occurs. Each type of atom has a programmatic rule that indicates how to incorporate and reconcile an incoming atom with the same atom already in the database

In one embodiment, an asset record is an atom. In some embodiments, asset records label, identify and name information resources known as assets (the resources including files, database records, email messages, etc.). In one of these embodiments, an asset record maintains meta-information identifying an origin or source location for the asset and other tracking information, In another of these embodiments, check-summing an asset record enables verification of the asset based on only the information stored within the asset record. In still another of these embodiments, the asset record identifies a version of the asset.

In some embodiments, a resource 30 may be a file system. In one of these embodiments, the file system could be some or all of an operating system's existing file system, such as C:\ or /home/user_name. In one embodiment, a user's files would be stored in a file system, and functionality is provided to backup or archive information from the file system or restore some or all of the file system in an event of a failure or accidental deletion.

In some embodiments, a resource 30 may function as a repository. In one of these embodiments, a repository is a resource used to store raw information assets as blocks of data. The repository may be organized into one large file that is internally segmented by each asset. The repository may be organized as a file system, where each block of information is stored as a single file. In another of these embodiments, a repository is a location into which a software agent 20 can store a block of bytes, generate a unique identifier used to find that block later, and retrieve a block stored in the repository. In still another of these embodiments, a repository provides a way to remove, modify, or reorganize information stored on the repository. In yet another of these embodiments, repositories provides a location in which data may be stored and kept for backup, archival or storage purposes. In other embodiments, a repository is organized as a file system.

In still other embodiments, meta-information representing asset records, receipts, projections, etc., may be stored in a repository. In one of these embodiments, the meta-information may be stored in a structured database.

In some embodiments, the elements of a data catalog that apply to a particular asset stored in a repository (such as a local copy of records including receipts, projections, asset records, and file meta-information) exist in a non-transient form on the physical media where the data is stored. A repository may be suddenly moved by a user, a system operator, or a software program from one node to another, or may potentially be damaged and only partially reconstructed. Furthermore, the structured information store used by the node to locally reference its knowledge of the rest of the network may become corrupt or may be destroyed. In one of these embodiments, the elements of the data catalog are protected by the data storage repository which itself maintains not just the assets themselves but also enough meta-information so that if the local catalog, the repository or individual assets were recovered in whole or in part, the elements of the local data catalog pertaining to assets found there could be reconstructed.

In another of these embodiments, each repository stores its assets along with associated meta-information as files, effectively keeping two copies of the information. The data items listed above may be serialized as an XML file that is either associated with or directly embedded within the actual block or file representing the stored asset. An asset may have a number of projections (defined in more detail below), file records, and other information related to it that are stored in this fashion. In some embodiments, checksum information allowing the file to be verified during a restore is also stored with the meta-information, allowing the restore operation to quickly decide which elements of the repository are intact and can be re-incorporated into the data catalog. In other embodiments, if the physical media fails or the quality of the database's version of the structured data is called into suspect, a restore operation can reconstruct most of the meta-information simply by scanning through each “asset bundle”. This allows a restore tool to be very flexible. For instance, bundles could be copied into another repository using a standard file copying tool, and that resource could integrate the new assets into its existing assets.

In one embodiment, an asset-based repository is recoverable in the event of a whole or partial disk failure. In another embodiment, such a repository may be organized into files, and an administrator may, manually or with a standard tool, move as many recoverable asset bundles into the working area of a new repository. In still another embodiment, the new repository may have the same ID as the previous repository. Once the asset-bundles have been reconstructed within the new repository, they are reincorporated into the local data catalog. In some embodiments, functionality is provided to perform a scan for each bundle, verify it, and read the meta-information into the database.

Referring still to FIG. 1A, in some embodiments, a software agent 20 provides a means for organizing the transmission, receipt, storage and verification of one or more data assets on a node 10. In one of these embodiments, a software agent 20 is associated with at least one node 10. In another of these embodiments, a software agent 20 is associated with at least one resource 30 on a node 10. In still another of these embodiments, a software agent 20 sends, receives, verifies, moves, deletes, copies, scans, or manipulates assets.

In other embodiments, a software agent 20 monitors a node 10 or a resource 30 with which the software agent 20 is associated. In one of these embodiments, the software agent 20 identifies new assets on the node 10 or resource 30. The software agent 20 may identify a new asset upon creation of a new asset. The software agent 20 may identify a new asset upon modification of an existing asset. In another of these embodiments, the software agent 20 generates and maintains a mapping between assets on a node 10 and a file system on the node 10. In still another of these embodiments, the software agent 20 accesses a rule and take an action responsive to the rule. Rules may cause the software agent 20 to take an action internally, to send or receive messages or files to or from other software agents 20′, update an asset record, a log, a receipt or state. In yet another of these embodiments, the software agent 20 scans an existing database or file system on a resource and create asset records and corresponding receipts for each item in the database or file system. In some embodiments, this monitoring functionality may be enabled through the use of checksums or other heuristics used to determine which files have changed. In other embodiments, a software agent 20 may implement a mechanism provided by an operating system to discover new or changed assess through a file change notification service such as fmon in IRIX or via a Windows API.

In still other embodiments, a software agent 20 may combine multiple files into a single asset or divide a single file into multiple assets. A software agent 20 may identify a plurality of files on a resource 30 that are to be maintained on a resource 30′. In one of these embodiments, the software agent 20 identifies each file in the plurality of files as an asset, generates an asset record for each file in the plurality of files and interacts with the software agent 20′ associated with the resource 30′ to request maintenance of each of the plurality of files separately. In another of these embodiments, the software agent 20 creates an asset comprising each file in the plurality of files, generates an asset record for the asset, and interacts with the software agent 20′ once to establish maintenance of the asset on the resource 30′. In still another of these embodiments, the software agent 20 creates an asset comprising a subset of the plurality of files, generates an asset record for the asset, and interacts with the software agent 20′ once to establish maintenance of the asset on the resource 30′. In yet another of these embodiments, the asset record for a single asset comprising multiple files allows a software agent to identify a single asset and receive information, validate, request, copy, or otherwise access or manipulate multiple files. In one embodiment, a software agent may divide a single asset into multiple assets and generate an asset record that associates the subset of assets to each other. In another embodiment, the division or aggregation of assets is referred to as a projection of assets. In still another embodiment, projections provide an arbitrary mechanism for naming subsets of assets and treating the subsets as a single asset for the purposes of any transaction in the system. For instance, to move an entire batch of files from a resource 30 to a resource 30′, the software agent establishes on resource 30 a projection of all of these files onto a new, single, virtual asset and requests that this asset be moved from resource 30 to a resource 30′.

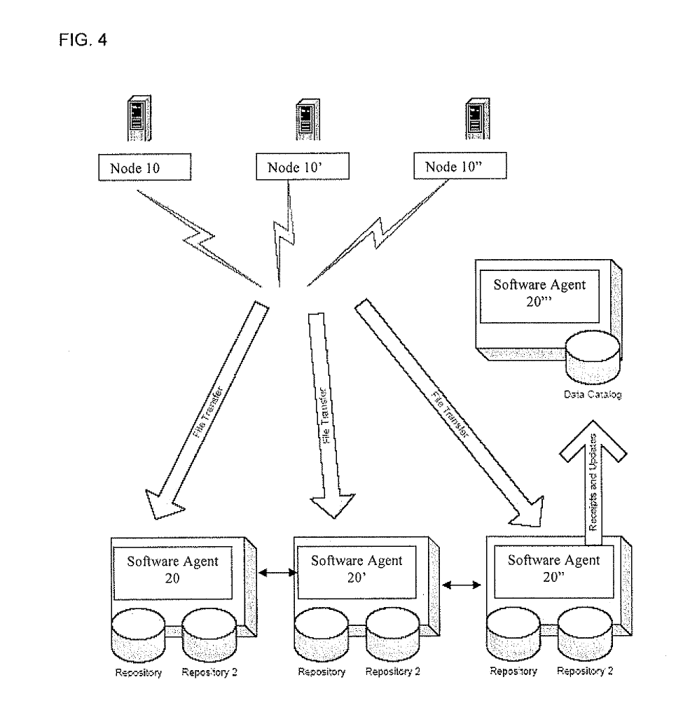

In some embodiments, a software agent 20 receives an asset or information associated with the asset and generates a data structure storing information associated with the asset. In one of these embodiments, the data structure is referred to as a receipt. Through creation, access, and exchange of receipts, agents and resources can create records that memorialize the presence or absence of a an actual asset at a particular time, the last time that information has been verified, the level or types of guarantees that the resource is providing that it will maintain that the asset in the future. Each receipt is itself an atom, meaning that a receipt can have a receipt. Receipts are described in further detail below, in connection with FIG. 5.

In yet other embodiments, a software agent 20 interacts with entities that do not comprise software agents. In one of these embodiments, a software agent 20 interacts directly with a node 10 or a resource 30. In another of these embodiments, a software agent 20 responds to a request for storage or retrieval of an asset received by a non-software agent. In still another of these embodiments, functionality for storage or retrieval of an asset is made available as a web service and a software agent 20 responds to requests for the functionality provided by the web service. In yet another of these embodiments, a software agent interacts with a software agent that is not part of the system.

In yet other embodiments, a software agent 20 interacts with a software agent 20′ to manipulate assets on nodes 10 and 10′. In one of these embodiments, the software agent 20 responds to a request for information about the node 10 or the resource 30 or an asset. In another of these embodiments, the software agent 20 determines a level of reliability or trust associated with the software agent 20′. The software agent 20 may determine a level of reliability or trust of the software agent 20′ prior to interacting with it, by participation in a trust management strategy. The software agent 20 may be associated with an attribute (a single- or multi-dimensional attribute) that forms a measure of how accessible and reliable the software agent 20 is at storing information.

In some embodiments, a software agent 20 may be configured to serve one or more repositories where data assets can be discovered, stored and verified. In one of these embodiments, the software agent 20 maintains its own private structured database of information either in memory or cached to disk, and uses either native operating system APIs or vendor-specific data management APIs to move, verify, copy, review, enumerate and transfer data with its repository or repositories. In some embodiments, a commercial and redundant structured relational or object database may provide a useful performance optimization for some of the software agents in the system. The data storage hardware that provides the various file systems or data areas that the software agent utilizes may be highly redundant (SAN, RAID5 or 10, etc.) or may be very cheap commodity off-the-shelf equipment with a low mean time between failure. In other embodiments, a repository may store files using less conventional means. In one of these embodiments, information could be written in semi-permanent or off-line form, such as DVD/+RW or WORM media. Depending on the specific application, a repository may also use network attached storage, SAN or web-services enabled network storage. In another of these embodiments, a repository may also preserve data on a remote server using existing file transfer protocols, such as FTP, WebDAV, or any other means.

In some embodiments, a software agent 20 provides functionality responsive to accessing one or more rules. In one of these embodiments, a software agent 20 takes an action upon accessing a rule. In another of these embodiments, an accessed rule includes a condition and the software agent 20 takes an action to satisfy the condition. For example, a software agent 20 may retrieve a data asset from a node 10 and store the data asset on a node 10′ to satisfy a condition requiring that the software agent 20 maintain a copy of the data asset on at least two nodes.

In other embodiments, a software agent 20 is configured with one or more roles and the software agent provides different functionality based upon the roles to which it has been assigned. The role a software agent 20 has impacts actions taken by the software agent 20, including actions taken responsive to messages, meta-information, asset records, and assets. In one of these embodiments, the conditions that a software agent 20 will satisfy and the obligations it will undertake on behalf of a node or resource with which it is associated may be determined based upon the role to which the software agent 20 was assigned.

In some embodiments, a software agent 20 connected to one or more repositories functions as a storage agent. In one of these embodiments, a software agent 20 functioning as a storage agent is configured to receive data assets and generate a type of record referred to as a receipt for each received data asset. The storage agent may store a received data asset in a repository to which the storage agent is connected. In another of these embodiments, a software agent 20 may receive data assets from one or more nodes 10, 10′, or from software agents 20′ associated with the one or more nodes 10, 10′. in still another of these embodiments, a storage agent may scan its repository, checking for errors in data assets. In an embodiment where the storage agent was assigned multiple roles, such as that of an agent in a replication group, the storage agent may take an action to repair errors identified in the repository. In one embodiment, an agent may revoke its receipt for an asset upon identification of an error. Either immediately, or upon a later review of its receipts, an agent may note that it does not have a receipt indicating an error-free copy of the asset exists, at which point the agent may retrieve a copy of the asset to maintain satisfaction of a condition. In yet another of these embodiments, a storage agent may satisfy requests for information about data assets from other software agents 20.

In other embodiments, a software agent 20 functions as a redirector. In one of these embodiments, a redirector receives requests for data assets or asset records associated with data assets. In another of these embodiments, a redirector identifies a software agent 20′ storing a copy of the requested asset record or associated with a repository or other resource 30 on which the requested data asset resides. In still another of these embodiments, a redirector satisfies a request for data assets or asset records by acting as an intermediary and receiving information from the identified software agent 20′ and transmitting the information to the requesting software agent. In yet another of these embodiments, the redirector satisfies a request for data assets or asset records by transmitting an identification of a software agent 20′ to the requesting software agent, enabling the requesting software agent to directly interact with the identified software agent 20′. In some embodiments, a redirector receives requests for functionality provided as a web service and transmits the request for the functionality to a software agent 20′. In one embodiment, therefore, the redirector may act as an interpreter between other data storage protocols (web services, FTP, etc) and the underlying protocol chosen.

In one embodiment, a software agent 20 is associated with a node functioning as a proxy. In another embodiment, the node receives incoming assets and requests associated with the asset In still another embodiment, the node determines which software agents on the network should receive copies of the asset or information associated with the asset, if any, and which software agents, if any, to assign to respond to the requests.

In still other embodiments, a software agent 20 functions as a backup and retrieval agent. In one of these embodiments, a backup and retrieval agent is connected to one or more file systems. In another of these embodiments, a backup and retrieval agent scans for changes made to files in the file system(s) by other processes on the system. In still another of these embodiments, upon detecting a change to a file system, the backup and retrieval agent updates an internal description of the file system to reflect the change to the file system, For example, in one embodiment, the backup and retrieval agent maintains a mapping between a plurality of files in a file system, or other resource 30, and identified data assets which comprise one or more files in the plurality of files. If a change in the file system is detected, the backup and retrieval agent may change the mapping to reflect the change to one or more files in the plurality of files and any associated data assets. Additionally, the backup and retrieval agent may generate data structures identifying the asset and information associated with the asset (referred to as a receipt and described in more detail below), and the backup and retrieval agent may update these data structures as well. In yet another of these embodiments, the backup and retrieval agent may transmit newly-discovered assets and meta-information may be transmitted to storage agents, redirection agents, proxies, or other software agents 20.

In some of these embodiments, the backup and retrieval agent may restore data assets. In one of these embodiments, the backup and retrieval agent requests a copy of a data asset from a storage agent. In another of these embodiments, the backup and retrieval agent consults a database to identify a storage agent connected to a repository storing a copy of a data asset. In still another of these embodiments, the backup and retrieval agent transmits a request for a data asset to a redirecting agent or other intermediate software agent 20′.

In others of these embodiments, a software agent 20 referred to as a replication agent provides the functionality of a backup and retrieval agent but also monitors and modifies a file system. The replication agent receives updates from other replication agents updates the local file system continuously responsive to those updates. This allows a group of files on one disk on one node to be replicated from disk to disk with the same contents across multiple nodes in a network.

In some embodiments, a software agent 20 is a referred to as a journal and acts as an aggregator of records and other meta-information, such as receipts and file descriptions. The journal aggregates this information from multiple nodes, storage units and replication agents, allowing for greater resiliency in the system (since the location of assets is stored by a separate entity from the storage unit that has stored them). The journal also provides additional support for decision-making, allowing for checks and other business rules to be implemented referring to data stored on multiple storage units. In some embodiments, all of a particular user's asset records and receipts regardless of storage unit, are kept on a single journal. In one embodiment, journals are replicated, providing additional protection for the aggregated information. In another embodiment, the aggregated information is partitioned amongst a plurality of journals. In still another embodiment, partitioning aggregated information amongst a plurality of journals is implemented using an arbitrary criteria determined by a particular implementation of the methods described herein.

In one embodiment, a software agent 20 associated with a storage unit referred to as a repository provides additional functionality for storing assets and information associated with assets. In another embodiment, the repository receives incoming asset records, assets and meta-information and saves the received data to a permanent or semi-permanent location (disk, removable storage, etc.). In still another embodiment, the repository generates receipts for these storage events and broadcasts copies of the receipts to software agents (including journals) throughout the network, selected responsive to rules or other configured conditions. In yet another embodiment, the repository may receive updates from other nodes to make a modification to its contents. For instance, if an account is revoked, a central service might send a “change obligation” message to every storage unit that contains those files asking it to remove them from its storage media. Since the storage unit can be configured to broadcast back new receipts when it has deleted those files, the rest of the system can confirm that the files have been deleted. In some embodiments, a storage unit referred to as a cache, receives requests for files from other nodes or through a retrieval protocol (such as FTP), and then identifies and retrieves the file, and stores a copy locally.

In some embodiments, a software agent provides peer-to-peer functionality. In one of these embodiments, a single peer-to-peer software agent provides the combined functionality of a storage unit, a journal, and a backup and retrieval agent, in addition to the controlling logic allowing the agent to participate in the network, functionality to determine the services it will provide, and infrastructure to route, cache or proxy messages, assets and atoms.

In some embodiments, software agents 20 communicate using a network protocol, such as TCP/IP, fibre channel or serial communications. In other embodiments, software agents 20 communicate via a message passing interface. In one of these embodiments, the message passing interface provides either a universal, domain-wide or self-organized registration and unique naming of nodes and the ability for a universal directory of certain common data items, such as resources and accounts. In another of these embodiments, the message passing interface provides NAT traversal or other firewall negotiation, including the use of reflectors or intra-node routing to allow as many nodes as possible to communicate within the network. In still another of these embodiments, the message passing interface provides authentication, data encryption and message reliability services, In yet another of these embodiments, conventional message passing interfaces used by those of ordinary skill in the art may be implemented to enable software agents 20 to communicate. In some embodiments, architectures similar to Java Message Service, or Web Services/SOAP may be used to implement this message passing interface. Further, improved efficiency may be provided by the use of a broadcast/multi-case mechanism. In some embodiments, the software agent or the underlying network layer may use encryption technology to ensure privacy and authenticity of communication between agents. In other embodiments, the software agent or underlying network layer may use Public Key Infrastructure technology to verify senders and receivers and verify the source or destination of a message.

In some embodiments, a plurality of data catalogs is stored on a node or a resource 30. A data catalog provides a representation of each node, resource or software agent's knowledge of the state of other nodes, resources or software agents in the system. A software agent may take actions responsive to accessing this representation. The representation provided by the data catalog may provide a basis for decisions made by software agents to store, verify, request, delete, or relocate data assets. In some embodiments, the data catalog providing the representation provides access to receipts as well as assets.

In one of these embodiments, the data catalog is maintained by a node 10 either in memory or in a disk-based structured relational, XML or object database. In another of these embodiments, each resource maintains a data catalog. In still another of these embodiments, a software agent maintains a data catalog for each node 10 or resource 30 with which it is associated. In yet another of these embodiments, the data catalog stores information available to the node, resource or software agent, including, but not limited to each asset record, receipt, file state record, projection, reliability score, resource record.

In one embodiment, an individual node, resource or software agent may have an imperfect or incomplete version of the entire data catalog. For example, the data catalog may include asset records for assets the node or resource no longer has or has never seen, or the records generated by other nodes, resources or software agents elsewhere in the network. In another embodiment, a node, resource or software agent maintaining a data catalog may update the data catalog periodically to ensure that data catalog provides an updated and accurate depiction of the information known to the node, resource or software agent. In still another embodiment, a data catalog is updated to reflect the result of a transaction between nodes, resources, or software agents. In yet another embodiment, a data catalog is a distributed data catalog stored over multiple nodes 10 throughout the network. In some embodiments, technology such as a distributed hash table may be implemented to enable the data catalog to handle situations where the data catalog contains an erroneous or incomplete identification of a node on which data resides. A distributed hash table does not allow for the programmatically controlled placement of where the data resides, or how many copies of the data exist, but may be implemented to assist in determining the location of data assets in situations where the local data catalog is incomplete.

In some embodiments, a method and system provide a generalized model, where data and redundant copies of the data are stored over a changing list of machines across a network, the model providing tolerance for failure of the machines and the ability to flexibly relocate the information. In one embodiment, the method and system may provide redundant storage or archives of information through the use of cheap, failable and commodity data storage hardware.

In one of these embodiments, a redundant, distributed and decentralized data catalog indicates where data has been stored. Flexibility in the data catalog allows flexibility to move information from place to place after it has been initially stored, and configurable rules to determine where data is initially stored. The data catalog may be distributed. In one embodiment, there is a data catalog for each software agent 20 in a network and the data in the data catalog provides a representation of each software agent 20's knowledge about the network. In another embodiment, some software agents 20 maintain customized data catalogs as part of a role the software agents 20 fulfill. For example, an agent may maintain a data catalog storing the locations of all of the files of a particular user, or storing an identification of all of the data stored at a particular resource, node, portion of the network, or geographic location. In some embodiments, a software agent 20 maintains one or more data catalogs based on an application of a rule, such as a role, application of an algorithm, functionality the software agent 20 provides, or a condition the software agent 20 has determined to satisfy. In other embodiments, a software agent 20 maintains one or more data catalogs in an ad hoc manner, for example by storing only information that the software agent 20 has manipulated. In still other embodiments, a data catalog is a distributed data catalog. In one of these embodiments, a plurality of software agents 20 store and maintain portions of the data catalog.

In another of these embodiments, information is transmitted amongst software agents 20 via a meta-protocol allowing data block transfer to be orchestrated by different nodes 10 in a network, and different types of data preservation obligations to be set on particular nodes 10. In still another of these embodiments, multiple data assets may be referred to as one single asset, or large assets may be referred to as smaller, sub-divided assets. Enabling the spitting and joining data blocks increases efficiency of the system by improving the efficiency of dealing with very large assets or with numerous very small assets. In yet another of these embodiments, hardware failures, or other types of data loss, are detected and mechanisms for performing state-recovery are provided.

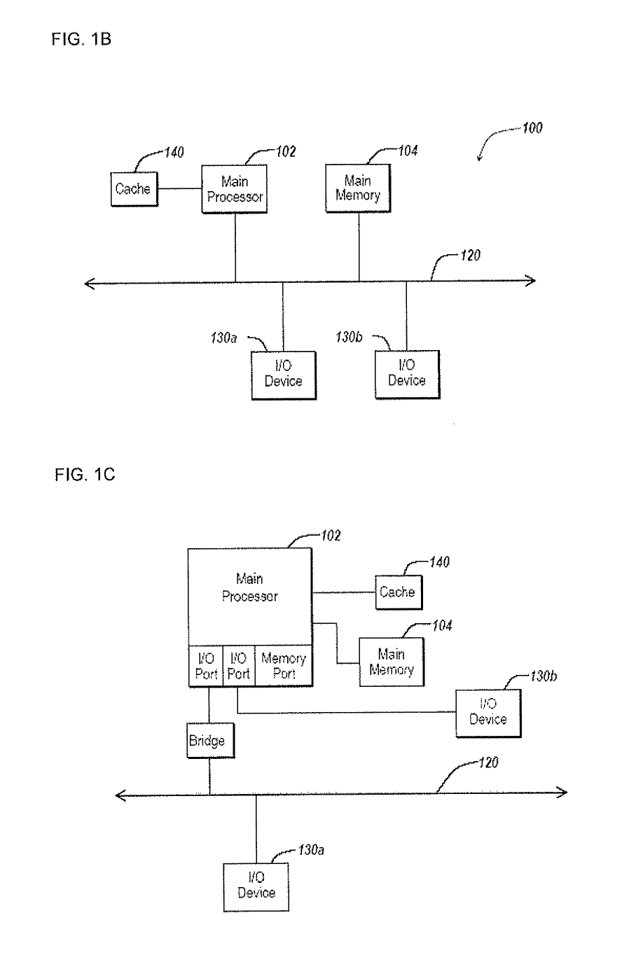

In one of these embodiments, an interface for the movement and management of data is provided such that a programmatic rule enforcement agent can ensure certain rules are maintained. Enforcement of rules may be triggered, and can vary, based on factors such as the configuration of a software agent and information known by the software agent, including information about nodes in the network, known asset records and receipts, virtual path tags against assets (which will be described in further detail below, in connection with FIG. 2), reliability of other software agents, and the role of the agent in the network. In another of these embodiments, functionality is provided for tagging, sorting and categorizing files of information across multiple servers, customers, and machines into one directory. In still another of these embodiments, support is provided for the backup and restoring of data blocks, file meta-information and a wide variety of different types of computer information including database records. In yet another of these embodiments, the system is tolerant of network failures, disconnected nodes and unreliable data transport protocols.

In one of these embodiments, mechanisms are provided enabling software agents to cryptographically challenge other less-trusted agents to ensure those agents are preserving their obligations to preserve data. In another of these embodiments, mechanisms are provided for measuring reliability and projecting the amount of redundancy needed to provide a level of service given measured agent reliability.

In some embodiments, a software agent 20 uses a challenge mechanism to verify that a software agent 20′ maintains an obligation it has undertaken. In other embodiments, a software agent 20 uses a challenge mechanism that requires receiving from a software agent 20′ a specific portion of a data asset stored at a location with which the software agent 20′ is associated to verify that a valid copy of the data asset is maintained. For example, the software agent 20 could request the first 282 bytes (or other randomly selected number of bytes) starting at a particular position within a file.

In some embodiments, the use of challenge mechanisms provides software agents 20 with a method for verifying the location of an asset. In one of these embodiments, software agents 20,20′ having varying levels of trust with each other may use challenge mechanisms to verify the location or state of an asset for which another, potentially less-trusted software agent 20 claims to have undertaken a particular obligation. In another of these embodiments, if a software agent 20 requires verification that a software agent 20′ has received an asset, or maintained a copy of it, the software agent 20 can pre-compute or randomly select one or more challenges to send to the software agent 20′. In still another of these embodiments, the challenge mechanisms vary and the software agent 20′ cannot predict the challenge mechanism it will have to satisfy, or what data it will need to satisfy the challenge mechanism, decreasing the likelihood of falsification of the results by software agent 20′. In yet another of these embodiments, a software agent 20 can implement challenge mechanisms which do not require the challenging software agent 20 to have possession of a data asset for which it is seeking verification, such as a mechanism in which the software agent 20 requests particular segments of a data asset and performs verification operations on received segments. In one embodiment, over an extended period of time, a non-repeating set of challenges can exist that software agent 20 poses to software agent 20′, without ever having the asset.

In some embodiments, a software agent 20 receives a response to a challenge mechanism from a software agent 20′. In one of these embodiments, a software agent 20 stores received responses to one or more challenge mechanisms. In another of these embodiments, a software agent 20 stores information associated with a response to one or more challenge mechanisms, including, without limitation, a number of failed challenges, a number of forged responses, a number of false positive, an amount of time lapsed before a response was received, and an amount of time in which the challenged agent was unavailable. In still another of these embodiments, a software agent 20 formulates a metric of reliability for a software agent 20′ for whom it has saved responses to challenges, responsive to information associated with the responses.

Referring now to FIG. 2, a flow diagram depicts one embodiment of the steps taken in a method for providing data storage and retrieval. An asset stored by a first resource is identified (step 202). An asset record identifying the asset is identified (step 204). One of the following is transmitted to an agent associated with a second resource: (i) the generated asset record, (ii) metadata associated with the asset, (iii) a description of a condition associated with the asset, (iv) the generated asset record and metadata associated with the asset, (v) the generated asset record and a description of a condition associated with the asset, (vi) the asset and metadata associated with the asset, (vii) the asset and a description of a condition associated with the asset, (viii) metadata and a description of a condition associated with the asset, (ix) the generated asset record and the asset and a description of a condition associated with the asset, and (x) the generated asset record and the asset and metadata associated with the asset. (step 206). In one embodiment, the method provides functionality for data storage and retrieval functionality, including, but not limited to, data backup, data distribution, data caching, file replication, data retrieval.

In brief overview, information to be stored, archived or moved is enumerated and categorized as an asset and an asset record, such as a distributed database record, is generated for each asset. Assets are routed to storage agents, either by a push or pull. As other storage agents store or transfer information, records referred to as receipts are generated reflecting the presence or absence of information.

Referring now to FIG. 2, and in greater detail, an asset stored by a first resource is identified (step 202). In one embodiment, a block of information on a first resource is identified. In another embodiment, information stored on the first resource is classified as an asset. In some embodiments, the first resource is a node 10. In other embodiments, a first resource is a resource 30 residing on a node 10. In one embodiment, software agents enumerate and categorize information to identify the asset. In another embodiment, a software agent 20 is associated with the first resource.

An asset record identifying the asset is generated (step 204). In one embodiment, a unique identifier is generated and associated with the asset. In another embodiment, the asset record is a distributed database record. In still another embodiment, a previously-generated asset record is identified. For example, a database storing the generated asset record may be accessed or the generated asset record may be received from a software agent 20 or a node on the network.

In one embodiment, a software agent 20 generates the asset record. In some embodiments, an asset record may be referred to as an atom. In other embodiments, local asset records and distributed asset records are generated for the asset. In still other embodiments, asset records are published to a central or distributed receipt aggregation server. In yet other embodiments, asset records are transmitted to a software agent 20 associated with the first resource.

In some embodiments, rules are configured to monitor for changes to records on various nodes 10, causing a software agent 20 to react if the rules are violated. In one of these embodiments, rules may be enforced by the software agent 20 associated with a resource 30 storing the data, the software agent 20 originally identifying the data asset, or by a separate rule enforcement agent.

In some embodiments, a software agent identifies an asset on a resource and generates an asset record for the asset. In one of these embodiments, the software agent also generates a file state and virtual path (described in further detail below) for the asset. In some embodiments, assets are connected to user files through a level of indirection. User files on disk may change frequently as users or applications access files on a node. For instance, letter .doc may be updated twice after it is created, creating three different “impressions” of bits. This sequence of events could create as many as three assets, one for each version of the file. Therefore, in some embodiments, a file state is generated, providing a record representing a file and a set of meta-information that is operating-system dependent at a particular point in time. Current and previous versions of the file may be stored in separate file states may be maintained by a software agent. In some embodiments, meta-information associated with the file states may be stored locally or transmitted to a remote location. In one embodiment, file states can be mapped to a drive either by scanning periodically, or working with hooks in the operating system to detect file changes. For a given actual file on disk such as C:\user\lettter .doc”, there may be an entire set of file states, with each file state associated with an asset representing the actual bits of information in that file at the time. In these embodiments, each file state will point to a) the asset record for the stream of bits that is the asset and b) the metadata accompanying the file in the file-system.

In some embodiments, file states are identified in a universal virtual file system spanning multiple users and/or organizational domains. In one of these embodiments, for each directory or volume to be protected, a virtual system-wide name (a virtual path) is generated or assigned. For instance a user's laptop having a drive labeled C:\may be actually thought of as /universalservice/customers/user/laptop1/cdrive, and therefore c:\user\letter .doc would be mapped as /universalservice/customers/user/laptop1/cdrive/Jeremy/letter .doc. This mapping means that multiple agents can synchronize files by assigning two different file system resources to the same virtual path location and, either a) periodically or b) through an event-driven mechanism, synchronize between the virtual directory and the actual directory found on disk. Additionally, entries within the virtual path may themselves be versioned.

One of the following is transmitted to an agent associated with a second resource: (i) the generated asset record, (ii) metadata associated with the asset, (iii) a description of a condition associated with the asset, (iv) the generated asset record and metadata associated with the asset, (v) the generated asset record and a description of a condition associated with the asset, (vi) the asset and metadata associated with the asset, (vii) the asset and a description of a condition associated with the asset, (viii) metadata and a description of a condition associated with the asset, (ix) the generated asset record and the asset and a description of a condition associated with the asset, and (x) the generated asset record and the asset and metadata associated with the asset. (step 206). In one embodiment, one or more of the above-mentioned types of information are transmitted. In some embodiments, metadata includes maintenance or verification information associated with the asset. In other embodiments, a software agent 20′ receives the information and identifies and satisfies a condition associated with the asset based upon the received information.

In one embodiment, a software agent 20 associated with the first resource, such as a resource 30, selects information to transmit to a second software agent 20′, the software agent 20′ associate with a node 10′ or resource 30′. In another embodiment, the software agent 20 selects the information responsive to accessing a rule. In still another embodiment, a software agent 20″, not associated with the first resource, selects information to transmit to a software agent 20′. In yet another embodiment, a software agent 20′, receiving information from a software agent 20″, contacts a software agent 20 associated with the first resource and requests additional information associated with the asset.

In one embodiment, a software agent 20 transmits the information to a software agent 20″ associated with a proxy. In another embodiment, a software agent 20″ receives the information and identifies a software agent 20′. In still another embodiment, either the software agent 20″ or the proxy forwards the information to the identified software agent 20′. In yet another embodiment, the software agent 20 transmits the information to both a software agent 20′ associated with a resource 30′ and to a software agent 20″ associated with a resource 30″.

In some embodiments, a software agent 20 transmits a data asset to a software agent 20′. In one of these embodiments, the software agent 20 encrypts the data asset or information related to the data asset prior to transmitting the data asset. Transmitted data may be encrypted using commonly known hash functions such as MD5 or the SHA hash functions, or other commonly known cryptographic algorithms such as RSA, Diffie-Hellman, elliptic curve public key cryptosystems, DSS, IDEA, RC4, SAFER or others. In another of these embodiments, the software agent 20 receives a key with which to encrypt the data. In still another of these embodiments, the software agent 20 receives the key with which to encrypt the data and does not transmit the key to any other software agent 20. In this embodiment, the transmitted data asset cannot be decrypted by the receiving software agent. In yet another of these embodiments, the software agent 20 receives an encryption key from a user of a node or resource on which the data asset resides. In other embodiments, the software agent 20 transmits the data over an encrypted connection.

In one embodiment, the software agent 20 determines whether a copy of the asset resides on a resource in a plurality of resources. The software agent 20 may consult a rule, a record such as a receipt, or a database of known resources to identify a resource in the plurality of resources on which a copy of the asset, or information associated with the asset, should be stored. In another embodiment, the software agent 20 consults at least one receipt when determining whether a resource in the plurality of resources stores the copy of the asset. In still another embodiment, the software agent 20 identifies a software agent 20′ to which to send the selected information responsive to consulting the at least one receipt. In yet another embodiment, the software agent 20 consults a rule to identify a software agent 20′ to which to send the selected information. In some embodiments, the software agent 20 identifies a software agent 20′ responsive to identifying a resource in a plurality of resources.

In one embodiment, the software agent 20 transmits a condition to the software agent 20′. In another embodiment, the software agent 20 transmits to the software agent 20′ a request for an indication of acceptance of the described condition. In still another embodiment, the software agent 20′ satisfies the condition.

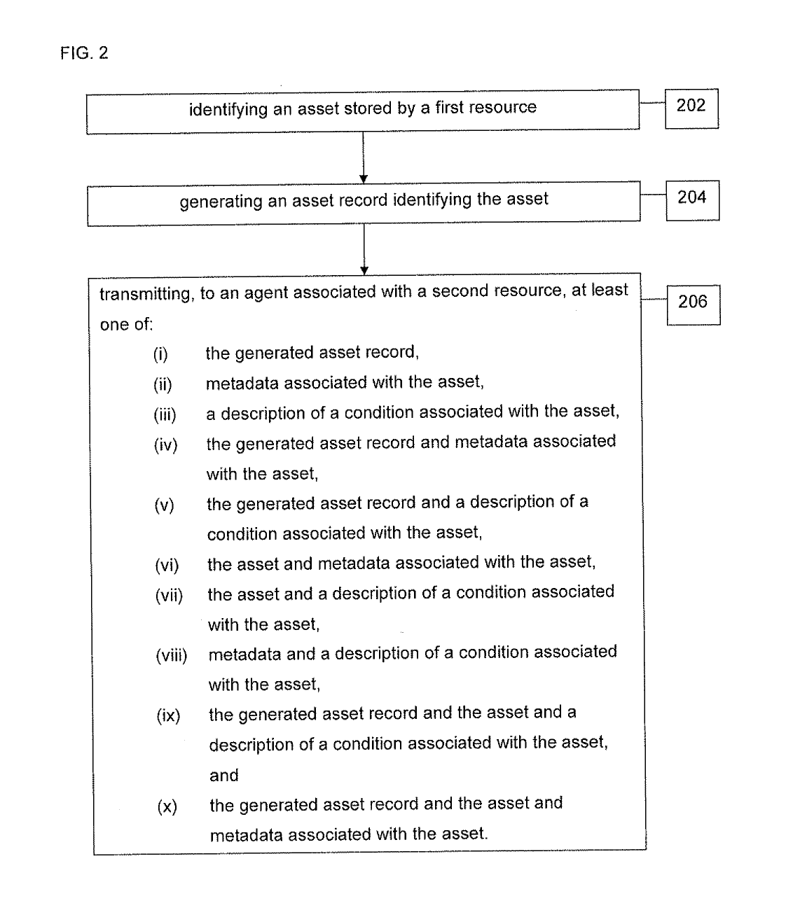

Referring now to FIG. 3, a flow diagram depicts one embodiment of a method of providing data storage and retrieval. At least one of the following are received from an agent associated with a resource: (i) an asset record identifying the asset, (ii) metadata associated with the asset, (iii) a description of a condition associated with the asset, (iv) the asset record and metadata associated with the asset, (v) the asset record and a description of a condition associated with the asset, (vi) the asset and metadata associated with the asset, (vii) the asset and a description of a condition associated with the asset, (viii) metadata and a description of a condition associated with the asset, (ix) the asset record and the asset and a description of a condition associated with the asset, and (x) the asset record and the asset and metadata associated with the asset (step 302). A determination is made to satisfy a condition associated with the asset (step 304).

An asset, or information associated with an asset are received from an agent associated with a resource (step 302). In one embodiment, the information is received from a software agent 20 associated with a resource 30 or a node 10 on which the asset resides. In another embodiment, the information is received responsive to a request for the information. In still another embodiment, the information is received by a software agent 20′ associated with a node 10′ or a resource 30′. In yet another embodiment, the information is received from a software agent not affiliated with the resource 30 on which the asset resides, such as a proxy.

In one embodiment, the generated asset record is incorporated into a database accessible by a software agent 20′. In another embodiment, received metadata is incorporated into a database. In still another embodiment, received metadata is stored on a resource 30′.

In one embodiment, the asset is received and stored on a resource 30′. In another embodiment, an indication of the existence of the asset on a resource 30′ is transmitted to a software agent 20. The software agent 20 may be associated with the resource 30 on which the asset resides.

A determination is made to satisfy a condition associated with the asset (step 304). In one embodiment, a software agent 20′ determines to satisfy the condition. In another embodiment, the software agent 20′ receives a description of the condition associated with the asset. In still another embodiment, the software agent 20′ satisfies an implicit condition, for example, by enforcing a rule. In yet another embodiment, the software agent 20′ associated with a resource 30′ satisfies the condition. In some embodiments, a determination is made not to satisfy the condition. In other embodiments, at least one rule is accessed to satisfy a condition.

In one embodiment, a data structure is generated identifying the asset, identifying a local resource, indicating whether the asset resides on the local resource, and a condition associated with the asset. In another embodiment, the data structure, or a copy of the data structure, is stored in a data catalog. In still another embodiment the data structure, or a copy of the data structure is transmitted to another software agent 20. In some embodiments, a software agent 20′ receives an asset, or information associated with the asset, from a software agent 20 and generates the data structure responsive to the received asset or information associated with the asset.

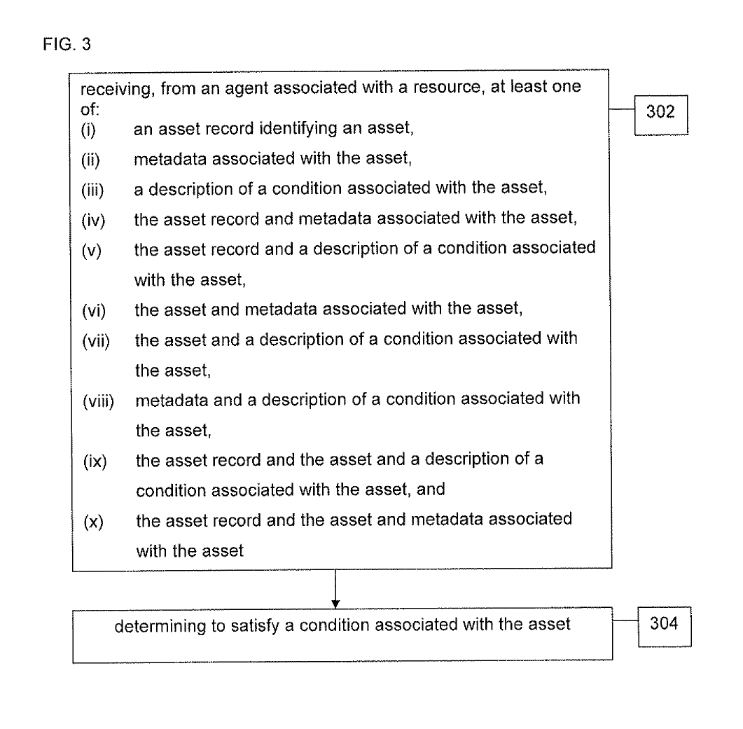

Referring now to FIG. 4, a block diagram depicts one embodiment of a system in which software agents provide data backup services over a network. The system includes a means for receiving one of the following: (i) an asset record identifying the asset, (ii) metadata associated with the asset, (iii) a description of a condition associated with the asset, (iv) an asset record and metadata associated with the asset, (v) an asset record and a description of a condition associated with the asset, (vi) the asset and metadata associated with the asset, (vii) the asset and a description of a condition associated with the asset, (viii) metadata and a description of a condition associated with the asset, (ix) an asset record and the asset and a description of a condition associated with the asset, and (x) an asset record and the asset and metadata associated with the asset. In some embodiments, one or more of the above-mentioned types of information are received.

The system includes a means for determining to satisfy a condition associated with the asset. In some embodiments, software agents include the means for determining to satisfy a condition and for satisfying the condition. In one embodiment, the means for satisfying the condition further comprises a means for storing the asset on at least one resource. In another embodiment, the means for satisfying the condition further comprises a means for transmitting an indication of the existence of the asset on at least one resource. In still another embodiment, the means for satisfying the condition further comprises a means for accessing at least one rule to satisfy the condition. In yet another embodiment, the means for satisfying the condition further comprises a means for receiving a description of the condition associated with the asset from a second agent. In some embodiments, the means for satisfying the condition further comprises a means for determining not to satisfy the condition.

As depicted in FIG. 4, a software agent 20 may be associated with a repository, which is a resource 30 as described above in connection with FIG. 1A, and also be associated with a node 10. In some embodiments, the software agent 20 receives information from the node 10 and stores the information received in the repository. In other embodiments, the software agent 10 transmits the information to other software agents.

In some embodiments, a software agent, such as software agent 20′″ in FIG. 4, is associated with a data catalog. In some embodiments, the software agent 20′″ is associated with a distributed data catalog. In other embodiments, each software agent is associated with a local data catalog. In still other embodiments, the software agent 20′″ interacts with the data catalog to provide the functionality of a journal.

Referring now to FIG. 5, a block diagram depicts one embodiment of a system of resources storing data structures identifying information associated with assets. In some embodiments, the data structure is referred to as a receipt. In one of these embodiments, the data structure provides functionality for publishing information on which redundant copies of data are stored to entities throughout a network. In another of these embodiments, when an asset is stored on a resource 30, this storage event is represented by a receipt. In still another of these embodiments, a receipt may be a data record indicating that a particular asset (“my letter .doc”) has been stored on a particular resource. In yet another of these embodiments, a receipt may include metadata associated with an asset, such as an indication of when and how existence of an asset on a resource was last verified.

In FIG. 5, the block diagram depicts receipts associated with separate resources. In one embodiment, a receipt includes an identification of the asset, such as the asset record for the asset, and a resource associated with the asset. Two receipts and an asset are stored on Resource 1: a receipt indicating that a copy of asset 1 resides on Resource 1, a receipt indicating that Resource 3 lacks a copy of asset 1, and asset 1. In some embodiments, a resource may be associated with an asset without storing a copy of the asset. In one of these embodiments, a receipt includes an indication as to whether or not the resource stores a copy of the asset. For example, one receipt on Resource 2 indicates that Resource 2 lacks a copy of asset 1 but requires a copy of the asset to satisfy a condition. Alternatively, the resource may be a resource on which a copy of a second receipt is maintained, and the second receipt may identify a second resource on which a copy of the asset resides, as shown by the receipt indicating that Resource 1 has a copy of asset 1. Resource 3 stores neither the asset nor a receipt. Since multiple resources may reside on individual nodes in the network, and the resources may store different assets or different versions of assets or, as in the case of Resource 3 in FIG. 5, no assets at all. Resource 4 stores a copy of asset 1 and a receipt indicating the Resource 4 has a copy of asset 1.

In some embodiments, the receipt includes a description of a condition associated with the asset and satisfied by the resource. In one of these embodiments, the description of the condition indicates that satisfying the condition requires maintaining a copy of the asset on the resource. In another of these embodiments, the description of the condition indicates that satisfying the condition requires maintaining a copy of information associated with the asset.

Each receipt provides information that may be accessed later by a software agent seeking to satisfy a condition. In some embodiments, at least one receipt is generated each time a data asset is identified or stored, and copies of the receipt may be stored or accessed by multiple entities. An entity such as a resource or software agent requiring a copy of the asset can access the receipt and determine, based upon the receipt, on what resource in the network a copy of the asset resides, and identify which software agent to contact to request a copy of the asset. For example, a software agent associated with Resource 2 attempting to satisfy the condition that Resource 2 maintain a copy of Asset 1 may access the receipt indicating that Resource 1 maintains a copy of Asset 1 to identify a resource from which a copy of Asset 1 may be obtained.

In another embodiment, a receipt includes information describing how current or accurate the receipt is. For example, a receipt may include a date on which it was generated or a date on which it will expire. If the receipt indicates the presence or absence of the asset on the resource, the receipt may also include an indication of a date on which the presence or absence of the asset was verified.

In one embodiment, a receipt may contain the following information:
a unique ID of the asset that was stored, such as an asset record;
a unique ID of a resource that stored the asset;
information about whether the asset is actually there, the last time the presence of the asset on the resource was verified, and the manner in which it was last verified;
how long the asset will be stored, and whether the resource that currently stores the asset, or a software agent associated with the resource, has determined to satisfy the condition; and,
optionally, a location inside the resource that stored the asset, such as a path or i-node number.

FIG. 5 additionally depicts one embodiment of a system for providing data storage and retrieval including a means for accessing a data structure identifying an asset, identifying a resource associated with the asset, indicating that the asset resides on the resource, and identifying a condition associated with the asset; a means for consulting at least one rule associated with the asset; and a means for satisfying the condition. In one embodiment the data structure is a receipt. In another embodiment, a software agent 20 includes the means for consulting at least one rule associated with the asset. The at least one rule may identify a condition to be satisfied and in some embodiments, the software agent 20 includes a means for satisfying a condition identified by the at least one rule. In still another embodiment, the software agent 20 includes the means for satisfying the condition. For example, the software agent 20 associated with Resource 2 in FIG. 5 may consult at least one rule to determine that Resource 2 needs a copy of Asset 1 to satisfy a condition. The software agent 20 may access the receipts on Resource 2, determine that Resource 1 stores a copy of Asset 1, and acquire a copy of Asset 1 from Resource 1 to satisfy the condition. In other embodiments, to satisfy a condition, a software agent may include a means for applying at least one rule to the condition to determine an action to take to satisfy the condition. In one of these embodiments, a rule indicates a level of protection accorded to data assets. For example, a rule may indicate that a data asset associated with a particular class of users should be stored and maintained in two locations, or that the integrity of a particular type of data asset should be verified at particular, pre-defined points in time. In still other embodiments, the software agent 20 includes a means for determining not to satisfy the condition.

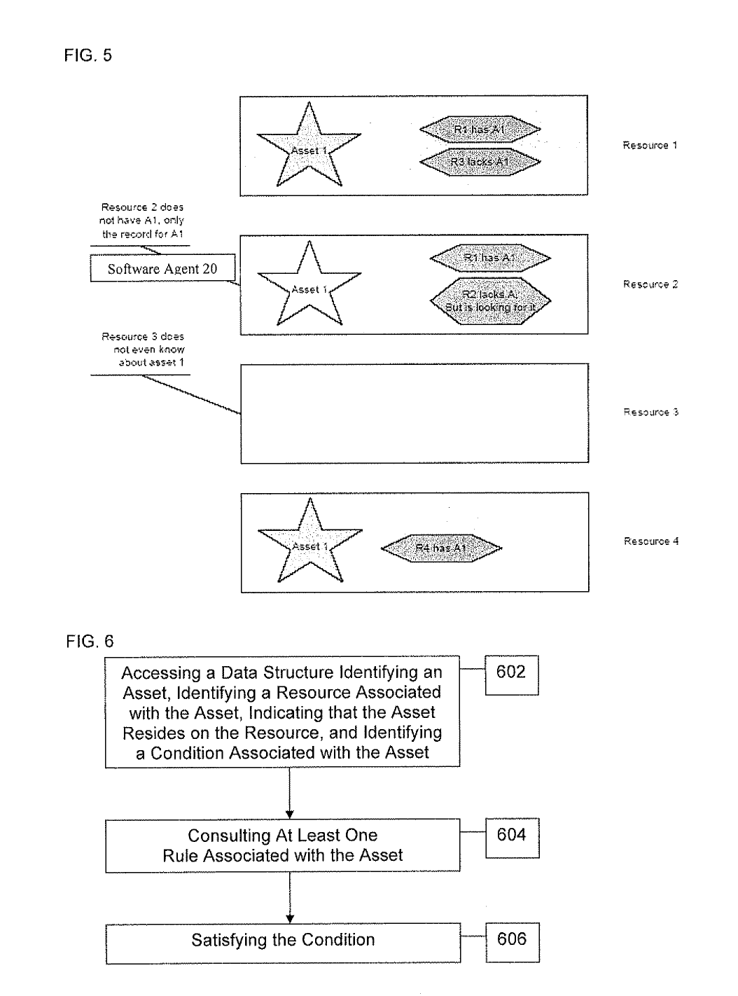

Referring now to FIG. 6, a flow diagram depicts one embodiment of the steps taken in a method for providing data storage and retrieval. A data structure is accessed, the data structure identifying an asset, identifying a resource associated with the asset, indicating that the asset resides on the resource, and identifying a condition associated with the asset (step 602). At least one rule associated with the asset is consulted (step 604). The condition is satisfied (step 606).

A data structure is accessed, the data structure identifying an asset, identifying a resource associated with the asset, indicating that the asset resides on the resource, and identifying a condition associated with the asset (step 602). In one embodiment, the data structure is a receipt, as described above in connection with FIG. 5. At least one rule associated with the asset is consulted (step 604). In one embodiment, a condition identified by the at least one rule is satisfied. In another embodiment, a software agent 20 consults the at least one rule and determines whether to satisfy any conditions identified by the at least one rule. The condition is satisfied (step 606). In one embodiment, the condition is satisfied by an application of the at least one rule to the condition. In another embodiment, the condition is satisfied by the manipulation of an asset on a resource by a software agent 20, including, but not limited to the copying or deleting of an asset or the copying, modifying, or deleting of information associated with an asset. In some embodiments, a determination is made not to satisfy the condition.

In some embodiments, a resource, or a software agent associated with the resource, makes a determination to satisfy a condition and a receipt includes information associated with the condition. In other embodiments, the information associated with the condition includes a description of the condition, such as a method selected for protecting the data asset or a time frame in which the resource will store a copy of the data asset. In one of these embodiments, satisfying a condition is referred to as an obligation owed by the resource, or the software agent associated with the resource. In another of these embodiments, to satisfy a condition a resource maintains a copy of an asset. Satisfying the condition may require maintaining the copy for a particular period of time. Alternatively, a condition may require storing a copy of the asset but without imposing a period of time during which the copy must be maintained. In still another of these embodiments, to satisfy a condition, a resource purges itself of a copy of an asset. In yet another of these embodiments, a resource maintains a copy of information associated with an asset but not a copy of the asset. In one implementation, this type of information could also be expressed as a “warrant.”

In some embodiments, a warrant is a data structure providing access to a plurality of rules. In one of these embodiments, a warrant may be transmitted by and amongst software agents 20. In another of these embodiments, a software agent 20 receiving a warrant receives a plurality of rules. In still another of these embodiments, a software agent 20 receiving a warrant determines to satisfy all conditions imposed by a plurality of rules described in the warrant. In one embodiment, a warrant provides the functionality of a service plan, describing a level of service to be provided by a software agent 20 satisfying the plurality of rules in the warrant. For example, a warrant may stipulate actions to take for particular data assets or types of data assets, such as a number of copies to store or maintain, periodicity of verification, and quality or reliability required of software agents maintaining the data assets. In another embodiment, when a software agent 20 seeks to impose an obligation to satisfy a condition upon a software agent 20′, the software agent 20 transmits the warrant in the meta-data transmitted to the software agent 20′. In still another embodiment, any software agent 20 transmitting the data asset or information or meta-information associated with the data asset to a software agent 20′ also transmits the warrant to the software agent 20′. In yet another embodiment, when a software agent 20, 20′ receives a warrant and a data asset, or information or meta-information associated with the data asset, it maintains an association between the data asset and the warrant. In still another embodiment, when a software agent 20, 20′ transmits a data asset for which it maintains an association with a warrant, it also transmits the warrant.

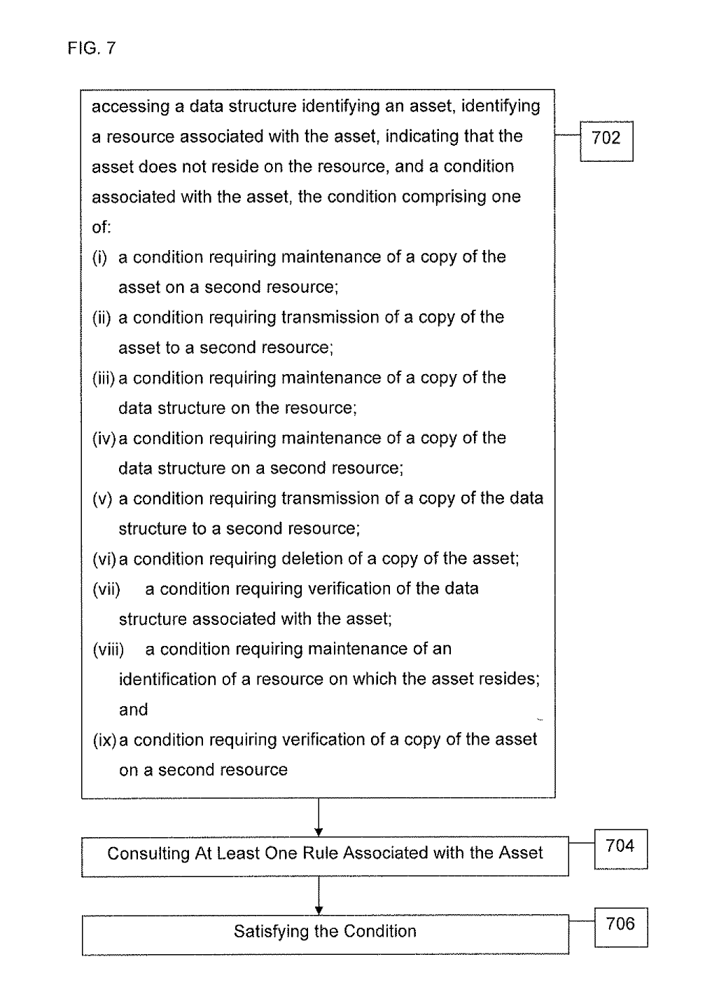

Referring now to FIG. 7, a flow diagram depicts on embodiment of the steps taken in a method for providing data storage and retrieval. A data structure is accessed, the data structure identifying an asset, identifying a resource associated with the asset, indicating that the asset does not reside on the resource, and a condition associated with the asset, the condition comprising one of; (i) a condition requiring maintenance of a copy of the asset on a second resource; (ii) a condition requiring transmission of a copy of the asset to a second resource; (iii) a condition requiring maintenance of a copy of the data structure on the resource; (iv) a condition requiring maintenance of a copy of the data structure on a second resource; (v) a condition requiring transmission of a copy of the data structure to a second resource; (vi) a condition requiring deletion of a copy of the asset; (vii) a condition requiring verification of the data structure associated with the asset; (viii) a condition requiring maintenance of an identification of a resource on which the asset resides; and (ix) a condition requiring verification of a copy of the asset on a second resource (step 702). At least one rule associated with the asset is consulted (step 704). The condition is satisfied (step 706).

A data structure is accessed, the data structure identifying an asset, identifying a resource associated with the asset, indicating that the asset does not reside on the resource, and a condition associated with the asset (step 702). In some embodiments, a software agent provides a means for accessing the data structure. In some embodiments, a condition associated with the asset may be satisfied without storing a copy of the asset on the resource. In one of these embodiments, the condition is a condition requiring maintenance of a copy of the asset on a second resource. A rule integrity agent satisfying such a condition may request verification from a software agent associated with the second resource that a copy of the asset resides on the second resource. In another of these embodiments, the condition is a condition requiring transmission of a copy of the asset to a second resource. A rule integrity agent satisfying such a condition may transmit a request to a third software agent to transmit a copy of the asset to the second resource. In still another of these embodiments, the condition is a condition requiring transmission to or maintenance of a copy of the data structure on the resource. A rule integrity agent satisfying such a condition may do so by transmitting a copy of the receipt to the second resource. In yet another of these embodiments, the condition is a condition requiring verification of the data structure associated with the asset. A rule integrity agent satisfying such a condition may transmit a request for an updated receipt from a resource on which a copy of the asset resides and verify the accuracy of the existing receipt by comparison to the updated receipt.

In some embodiments, the condition is a condition requiring maintenance of an identification of a resource on which the asset resides. A rule integrity agent satisfying such a condition may do so by requesting updated receipts from a software agent associated with the resource on which the asset resides to verify that a copy of the asset remains available on the resource. In other embodiments, the condition is a condition requiring verification of a copy of the asset on a second resource. A rule integrity agent satisfying such a condition may request verification of the validity of the copy of the asset by a second software agent, or request a copy of the asset itself using the asset record. In some embodiments, a condition requires verification of the veracity of a software agent associated with a resource on which a protected data asset resides. In one of these embodiments, a rule integrity agent satisfying such a condition may implement a challenge mechanism and verify the veracity of the suspect software agent responsive to the result of the challenge.

At least one rule associated with the asset is consulted (step 704). In one embodiment, a condition identified by the at least one rule is satisfied. In some embodiments, a software agent provides a means for consulting at least one rule associated with the asset. In other embodiments, a software agent provides a means for satisfying a condition identified by the at least one rule. In still other embodiments, a software agent provides a means for applying the at least one rule to the condition. The condition is satisfied (step 706). In one embodiment, at least one rule is applied to satisfy the condition. In another embodiment, a determination is made not to satisfy the condition. In some embodiments, a software agent provides a means for satisfying the condition. In other embodiments, a software agent provides a means for determining not to satisfy the condition.

In one embodiment, a software agent requests verification of the validity of an asset from a second software agent. In another embodiment, the software agent requests an updated receipt indicating that a valid copy of the asset still resides on the resource of the second software agent. In still another embodiment, the software agent may request a copy of the asset, or of a portion of the asset, to verify that a valid copy of the asset resides on the resource. If a software agent requesting from a second software agent verification of the accuracy of a receipt does not receive that verification, the software agent may determine that a request for satisfaction of one or more conditions (such as maintenance of a copy of the asset on a resource) should be transmitted to a different software agent.

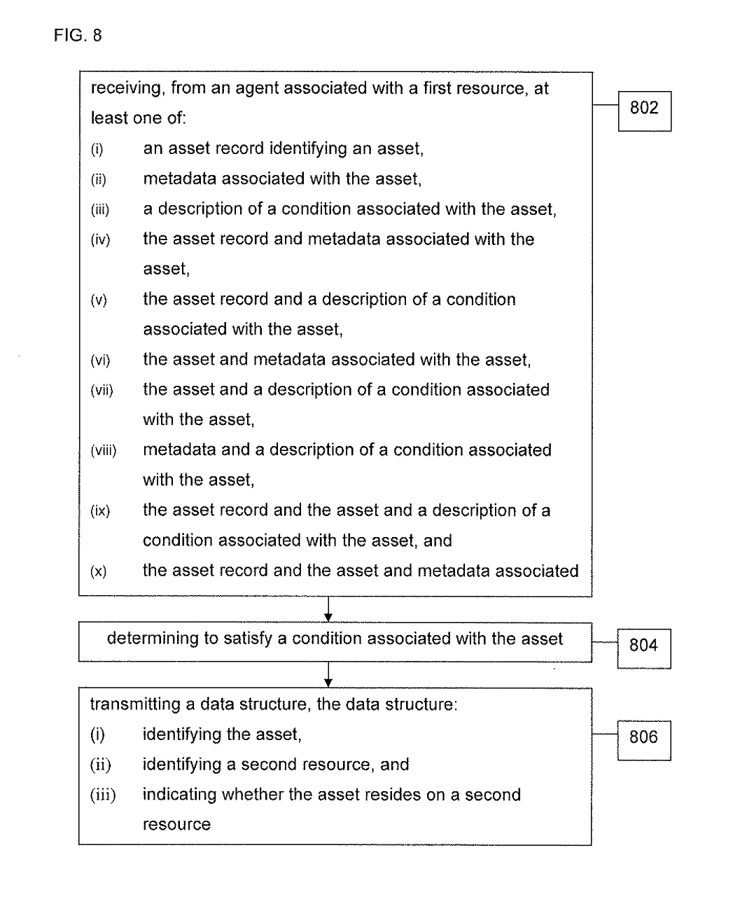

Referring now to FIG. 8, a flow diagram depicts one embodiment of the steps taken in a method for providing data storage and retrieval. An agent associated with a first resource receives at least one of the following: (i) an asset record identifying an asset, (ii) metadata associated with an asset, (iii) a description of a condition associated with an asset, (iv) an asset record and metadata associated with an asset, (v) an asset record and a description of a condition associated with an asset, (vi) an asset and metadata associated with the asset, (vii) an asset and a description of a condition associated with the asset, (viii) metadata and a description of a condition associated with an asset, (ix) an asset record and an asset and a description of a condition associated with the asset, and (x) an asset record and an asset and metadata associated with an asset (step 802). A determination is made to satisfy a condition associated with the asset (step 804). A data structure is transmitted, the data structure: (i) identifying the asset, (ii) identifying a second resource, and (iii) indicating whether the asset resides on the second resource (step 806).

An agent associated with a first resource receives at least one of the following: (i) an asset record identifying an asset, (ii) metadata associated with an asset, (iii) a description of a condition associated with an asset, (iv) an asset record and metadata associated with an asset, (v) an asset record and a description of a condition associated with an asset, (vi) an asset and metadata associated with the asset, (vii) an asset and a description of a condition associated with the asset, (viii) metadata and a description of a condition associated with an asset, (ix) an asset record and an asset and a description of a condition associated with the asset, and (x) an asset record and an asset and metadata associated with an asset (step 802). In some embodiments, an agent associated with a second resource receives the information. In one of these embodiments, a software agent 20 transmits the information to a software agent 20′. In other embodiments, the first resource and the second resource reside on a single node.

A determination is made to satisfy a condition associated with the asset (step 804). In one embodiment, a software agent 20 receiving the information evaluates the reliability of the agent from which it received the information prior to determining to satisfy the condition. In another embodiment, the software agent 20 evaluates a rule prior to determining to satisfy the condition. In still another embodiment, the software agent 20 evaluates an existing obligation to satisfy a condition prior to determining to satisfy the condition.

In some embodiments, a software agent may require information about the reliability of a second software agent. In one of these embodiments, the software agent may need the information in determining whether to undertake an obligation as requested by the second software agent. In another of these embodiments, the software agent needs the information when selecting the second software agent to satisfy a condition, such as the maintenance of a copy of an asset. In still another of these embodiments, the software agent accesses a central registration system to identify the second software agent.

In some embodiments, each resource carries a reliability factor indicating its reliability. Based on this reliability factor, a redundancy choice can be made by a software agent regarding on which resource to store a copy of the asset and how many extra copies are needed. In one of these embodiments, the resource, or the associated software agent, may be associated with an attribute (a single- or multi-dimensional attribute) that forms a measure of how accessible and reliable the resource is at storing information. In another of these embodiments, the measure of accessibility and reliability of the resource or an associated software agent is determined responsive to the results of challenge mechanism responses provided by the resource or by the associated software agent. Different assets may require different reliability scores from the resources on which they are able to be stored, or require satisfaction of additional conditions from lower-scoring resources—such as the maintenance of redundant copies on multiple resources. The reliability factors might be fixed by defined rules in the system as opposed to measured values based on particular peer's measured reliability. In some embodiments, the reliability factor may be measured by publishing a test block of random information to each network participant and periodically checking for the existence and validity of the block at random intervals.

A data structure is transmitted, the data structure: (i) identifying the asset, (ii) identifying a second resource, and (iii) indicating whether the asset resides on the second resource (step 806). In one embodiment, the transmitted data structure includes a condition associated with the asset. In another embodiment, an agent generates the data structure. In still another embodiment, the transmitted data structure includes metadata identifying a time of verification of the existence of the asset on the local resource. In yet another embodiment, the transmitted data structure includes metadata identifying a manner of verification of the existence of the asset on the local resource. In some embodiments, the data structure is a receipt. In some embodiments the indication of whether the asset resides on the second resource is not included in the data structure. In other embodiments, the identification of the second resource may be provided indirectly.

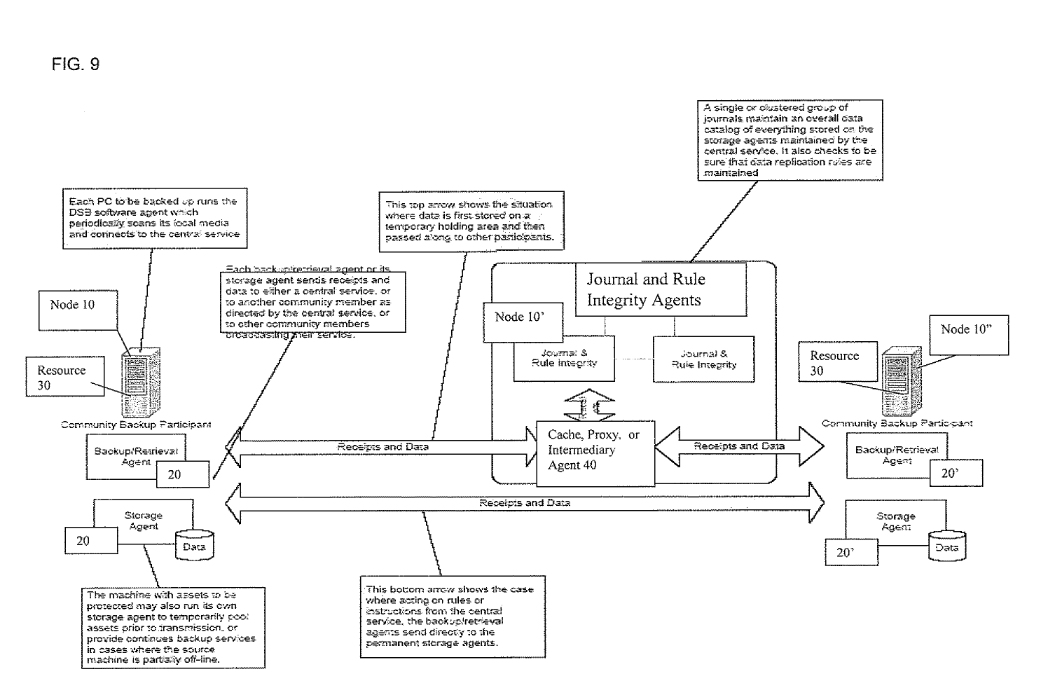

Referring now to FIG. 9, a block diagram depicts one embodiment of a system in which software agents provide data backup services over a network. The system includes a backup and retrieval agent 20 associated with a resource 30, a storage agent 20 associated with node 10 on which resource 30 resides, a proxy or intermediate agent 40 associated with the proxy, a node 10′ providing journal and rule integrity functionality, a backup and retrieval agent 20′ associated with a resource 30′, and a storage agent 20′ associated with node 100″ on which resource 30′ resides. The backup and retrieval agents 20, 20′, the storage agents 20, 20′ and the intermediate agent 40 may all be software agents 20. The backup and retrieval agents 20, 20′, the storage agents 20, 20′ and the intermediate agent 40 may each be separate software agents 20 or a single software agent 20 may provide the functionality of one or more of the backup and retrieval agents 20, 20′, the storage agents 20, 20′ and the intermediate agent 40.

It should be noted that although the agents, nodes, resources, and network elements shown in FIG. 9 depict one embodiment of the methods and apparatus described herein, in other embodiments, other configurations of the agents, nodes, resources, and network elements are implemented. For example, a cache agent 40 may also be a backup/retrieval agent or reside on a resource 30 or node 10, or eliminated from the implementation of one embodiment of the method. In another example of an alternate embodiment, a storage agent 20 may reside or be associated with an intermediate node 10′. In some embodiments, storage agents 20 and 20′ communicate with each other directly and not through an intermediate node 10′. In some embodiments, an agent associated with a node 10′ may delegate storage to a storage agent 20′ residing on a node 10″.

In one embodiment, the backup and retrieval agent 20 identifies new assets on resource 30 and interacts with the proxy and with other software agents 20 to maintain copies of the new assets on other resources 30′. In another embodiment, the storage agent 20 maintains copies of the new assets on the resource 30, on the node 10, or on other resources 30′.

The system includes a means for receiving, from an agent associated with a first resource, at least one of (i) an asset record identifying an asset, (ii) metadata associated with an asset, (iii) a description of a condition associated with an asset, (iv) an asset record and metadata associated with an asset, (v) an asset record and a description of a condition associated with an asset, (vi) an asset and metadata associated with the asset, (vii) an asset and a description of a condition associated with the asset, (viii) metadata and a description of a condition associated with an asset, (ix) an asset record and an asset and a description of a condition associated with the asset, and (x) an asset record and an asset and metadata associated with an asset; a means for determining to satisfy a condition associated with the asset; and a means for transmitting a data structure, the data structure: (i) identifying the asset, (ii) identifying a second resource, and (iii) indicating whether the asset resides on a second resource.

The system includes a means for receiving, from an agent associated with a first resource, at least one of: (i) an asset record identifying an asset, (ii) metadata associated with an asset, (iii) a description of a condition associated with an asset, (iv) an asset record and metadata associated with an asset, (v) an asset record and a description of a condition associated with an asset, (vi) an asset and metadata associated with the asset, (vii) an asset and a description of a condition associated with the asset, (viii) metadata and a description of a condition associated with an asset, (ix) an asset record and an asset and a description of a condition associated with the asset, and (x) an asset record and an asset and metadata associated with an asset. In one embodiment, the agent is a software agent 20, such as a storage agent 20 or a backup and retrieval agent 20. In another embodiment, the system includes a means for receiving the information from an agent associated with a second resource, such as a backup and retrieval agent 20′ associated with a resource 30′.

The system includes a means for determining to satisfy a condition associated with the asset. In one embodiment, a software agent 20 includes the means for determining to satisfy the condition. In another embodiment, the system includes a means for determining not to satisfy the condition.

The system includes a means for transmitting a data structure, the data structure: (i) identifying the asset, (ii) identifying a second resource, and (iii) indicating whether the asset resides on a second resource. In one embodiment, the data structure is a receipt. In another embodiment, the transmitted data structure includes a condition associated with the asset. In still another embodiment, the means for transmitting a data structure further comprises a means for generating the data structure. In yet another embodiment, the transmitted data structure includes metadata identifying a time or manner of verification of the existence of the asset on the local resource.

In some embodiments, a resource, or a software agent 20 associated with the resource, manipulates assets to maintain consistency between information contained in a receipt and the presence or absence of an asset on the resource. In one of these embodiments, a software agent having made a determination to satisfy a condition associated with an asset satisfies a condition and updates an existing receipt or generates a new receipt to indicate the current relationship between the asset and the resource. For example, if a receipt indicates that a particular resource is available on a particular resource and a condition identified in the receipt requires maintenance of a copy of the asset on the resource for a period of time, a software agent associated with the resource may verify that a copy of the asset exists on the resource and that the specified period of time has not lapsed. If the receipt indicates that the asset is not available on the resource but satisfaction of the condition requires availability of the asset on the resource, the software agent may acquire a copy of the asset, store the copy of the asset on the resource and update the existing receipt or generate a new receipt indicating that the asset is now available on the resource.

In some embodiments, a software agent referred to as a rule integrity agent is associated with the resource and maintaining consistency between the information in receipts and the state of the resource while satisfying one or more conditions associated with the resource. In one of these embodiments, the rule integrity agent associated with a resource has access to a plurality of receipts associated with the resource. In another of these embodiments, the rule integrity agent associated with a resource has access to a plurality of receipts associated with assets stored on the resource. For example, the rule integrity agent may have access to a receipt identifying a second resource on which a second copy of an asset resides. The rule integrity agent may consult such a receipt if it requires access to a second copy of the asset, for example, in the event of the deletion or corruption of the existing copy of the asset. In still another of these embodiments, the rule integrity agent may have access to a plurality of rules and conditions associated with the resource or with an asset stored on the resource. In yet another of these embodiments, a rule integrity agent may be associated with multiple resources.

In some embodiments, the use of receipts allows a software agent to arrange data transfers between other nodes. In one of these embodiments, a software agent has undertaken an obligation to maintain a copy of an asset on two separate resources. Although a copy of the asset may not reside on the resource with which the software agent is associated, the software agent may transmit a receipt to two separate software agents, associated with two separate resources, and seek to impose upon the software agents an obligation to satisfy the condition of maintaining copies of the asset on each of their respective resources. In another of these embodiments, the software agent additionally transmits to the two software agents a receipt identifying a resource on which the asset to be copied resides, enabling the two software agents to satisfy the condition by requesting copies of the asset from the identified resource (via its associated software agent) and maintain the copies on their resources.

In one embodiment, a software agent identifies a new asset on a resource monitored by the software agent. In another embodiment, the software agent may transmit an obligation receipt to a second software agent with a copy of the asset or with a receipt indicating the resource on which the asset resides. In still another embodiment, the software agent may transmit the obligation receipt to a second software agent with a copy of the asset and a second obligation receipt to a third software agent with a receipt identifying the second software agent's resource as the resource on which a copy of the asset resides. In yet another embodiment, second software agent stores the asset on its resource, automatically satisfying the condition, while the third software agent, acting as a rule integrity agent, contacts the second software agent, requests and receives a copy of the asset and stores the asset on its resource to satisfy the condition.

In some embodiments, a resource, or a software agent associated with the resource, may access receipts to perform a data transfer transaction. In one of these embodiments, a software agent determines to satisfy a condition requiring maintains of an asset on a second resource. In another of these embodiments, the software agent may send a request to the second resource for verification of the existence of the asset on the second resource. In still another of these embodiments, the software agent transmits a request for a receipt to a second software agent associated with the second receipt. The software agent receiving the receipt may verify that the receipt indicates that the asset is available on the second resource and, optionally, that the second resource has determined to satisfy a condition requiring maintenance of a copy of the asset on the second resource.

In one embodiment, an asset exchange message is exchanged by software agents to perform a data transfer transaction. In another embodiment, an asset exchange message includes a request for a valid receipt, the request including at least one parameter to be conveyed to one or more resources. In still another embodiment, an asset exchange message enables software agents to 1) agreeing on which asset(s) are to be transferred 2) optionally sharing information on the current known sources of those asset(s) in the form of receipts 3) optionally agreeing on a mechanism to exchange the assets, including a data transfer mechanism 4) optionally providing some or all of the asset within the message itself 5) setting an expectation as to how the transfer will be confirmed; that is, which resources should receive receipts that the transfer has taken place and how current those receipts need to be 6) an optional list of projections. In yet another embodiment, where a receipt is used to prove that an asset exists on a resource, an asset exchange message includes at least a request for a receipt, but need not cause an asset transfer. In some embodiments, a software agent receiving an asset exchange message may refuse to respond to the message or to participate in an asset exchange. In one of these examples, the determination to refuse to participate in the asset exchange may result from an evaluation of a reliability factor of the software agent transmitting the asset exchange message.

In some embodiments, a software agent unaffiliated with the node or resource where an asset resides or to which an asset will be moved may send an asset exchange message. In one of these embodiments, the software agent has an obligation to ensure that a copy of an asset resides on an unaffiliated node or resource and sends an asset exchange message to enable an exchange between two other software agents.

In one embodiment, a software agent associated with a node or resource on which an asset resides initiates an asset exchange to enable the direct transfer of the asset to another resource. In some embodiments, the software agent includes the asset, or a portion of the asset, in the asset exchange message. In one of these embodiments, a second software agent receiving the asset exchange message and the asset stores the asset on an associated resource and generates a receipt including the asset record, an identification of the resource, and an indication that the asset is available on the resource. In other embodiments, the software agent includes the asset record for the asset, but not the asset itself, and the second software agent first acquires the asset and then stores the asset on the resource and generates the receipt.

In one embodiment, a software agent requiring a copy of an asset identifies a second software agent associated with a resource storing a copy of the asset. In another embodiment, the software agent identifies the second software agent by accessing at least one receipt identifying the second software agent. In one embodiment, the software agent implements a distributed hash table to locate a receipt identifying the second software agent. In this embodiment, the software agent may access the distributed hash table if it does not have access to a receipt, for example, because its local portion of the data catalog does not have the receipt. The software agent may cooperate with other agents in using the distributed hash table to find a valid receipt. In still another embodiment, the software agent transmits to the second software agent a request for the asset and a receipt including the asset record, a resource identifier, describing the condition to be satisfied (maintenance of a copy of the asset on the resource), and indicating that the asset is not available. The second software agent transmits to the software agent an asset exchange message and transfers the asset to the software agent. In some embodiments, the software agent requires the copy of the asset because no copy ever existed on the resource but a determination has been made to satisfy a condition requiring maintenance of the asset on the resource. In other embodiments the software agent requires the copy because the asset has been deleted, corrupted or otherwise lost from the resource. In still other embodiments, the software agent requires the copy of the asset because a determination has been made to satisfy a condition requiring that an updated copy of the asset be retrieved and stored on the resource periodically.

In some embodiments, the software agent 20 transmits a request for generation of a receipt identifying an obligation the software agent 20 wishes to impose on a software agent 20′. In other embodiments, the software agent 20 uses an asset exchange message to communicate to a second software agent 20′ the obligation the software agent 20 wishes to impose. In one of these embodiments, if the second software agent 20′ accepts the transmission and the obligation, it may generate a null receipt with the obligation, which may be cryptographically signed. In still other embodiments, a resource, or a software agent associated with the resource, may use receipts to impose an obligation on a second resource, or a second software agent, to satisfy a condition. In one of these embodiments, the software agent may transmit a receipt indicating an obligation to be created.

In another of these embodiments, the software agent transmits to the second software agent at least one asset record, at least one receipt, at least one target resource, a description of a condition to be satisfied (which may be referred to as a warrant), and, optionally, metadata associated with the asset, such as network transmission preferences. In still another of these embodiments, the software agent may transmit to a second software agent a receipt identifying a resource on which a copy of the asset resides. In yet another of these embodiments, the software agent may transmit to the second software agent a copy of the asset. In one embodiment, the software agent transmits to the second software agent an identification of resources to which the second software agent should transmit receipts indicating acceptance of the obligation and satisfaction of the condition.

In some embodiments, the second software agent receives the receipt indicating the obligation, determines to accept the obligation, receives the receipt identifying the resource on which the copy of the asset resides, requests a copy of the asset and stores a copy of the asset to satisfy the condition. In other embodiments, the second software agent receives the receipt indicating the obligation, determines to accept the obligation, and determines that a copy of the asset already exists on the resource with which the second software agent is associated. In one of these embodiments, the second software agent generates a receipt identifying the asset (via asset record, for example), identifying the resource, indicating existence of the asset on the resource with which the second software agent is associated and, optionally, describing the condition.

Use Cases

By combining agents in various forms and various networks, the methods and systems described above can by applied to a variety of circumstances, some of which are described below.

Data Backup/Archival to Central Service

In this model, a company offers the ability for customers and business to backup or archive targets (such as PDAs, laptops, servers, workstations or other devices) to a central service. A software agent may be installed on these devices, or a separate agent may be installed to provide the ability to send and receive file information to one or more receiving points for data transfer. Within the actual “data backup service”, the technology is deployed over a vast array of geographically distributed and partially interconnected hardware systems containing attached data storage. The technology organizes the incoming information to be stored at one or multiple geographic locations within the central service.

In this instantiation, it is possible for the technology to be operated entirely privately within the organization or sub-organization providing the backup or archival service. The technology allows the hardware supporting the data storage at the central service to be relatively cheap and non-redundant. If a computer were to fail, the technology would allow hard drives to be moved from that computer to another computer and the node to be recovered. If a hard drive were to fail, a new one could be provisioned and the technology used to manually or automatically move other redundant copies of that data back onto the replacement drive. The technology would also allow a file or block-based recovery of that drive to occur, and the recoverable subset of the original information could be reconstructed onto a second drive with that information being reincorporated into network without the need to retransmit.

As the services change or grow, new data centers added, and new services defined data movement is constantly needed. For instance, a pricing structure could be used the makes more redundant copies available by paying more money to the service. Or different types of data could receive different amounts of redundancy or accessibility based certain criteria such as when it was backed up, which customer, which type of data, etc. The general data catalog and transfer mechanisms described above would facilitate the movement of data from place to place, and the assurance that a certain amount or type of distribution and redundancy had been achieved. The ability to define programmatic rule enforcement would allow the system to be largely self-operating to preserve the data placement decisions that had been made.

In this instantiation, it is likely that a strongly centralized data catalog would be useful. Here, the use of a replicated and redundant relational or object database would be beneficial even though the data storage elements themselves do not require any additional resilience.

Data Backup/Archival Delegated Model

The delegated model is a slight variation of the central service model. In this model, sources of information to be backed up or archived contact a central service, however the actual maintenance of the data repository lies within a federated and possibly sub-contracted network of organizations each providing hardware running the DSB agent or accessible to the DSB agent (over a network drive, etc.) In the delegated model the DSB technology allows a central service providing backup or archival services to maintain only the central catalog and storage node registry, effectively delegating control over the data to one or more other entities. These reliability of the software agents could be measured using the systems and the methods described above as part of the business or contractual arrangement, helping to set a price point and market for data storage based on accessibility and reliability. In some situations, challenge mechanisms described above may be implemented to verify the level of trust, accessibility and veracity of software agents. The implementation of challenge mechanisms may provide increased incentive for delegates to satisfy the conditions and obligations they undertake and increase the ability of a centralized service to monitor agent conformance to data storage directives.

Peer-to-Peer/Community Backup Models

In another embodiment, a model allows individual computers to participate in a data backup and archival relationship, both as sources and targets. In this model, users asks other users to backup their information and in return offers some of their own data storage back into the network for other users to back up to them. In this case, a central registration may be very light or non-existent. The technology's ability to deal with varying levels of trust among agents and its ability to score reliability and accessibility could help align the self-interest of the participants in ensuring overall system reliability. Users would be encouraged to make their machines more accessible so that the total number of additional copies needed to maintain data within the overall system would fall thus increasing the backup or archival capability of the community. Encryption and data splitting help ensure privacy. In one implementation, data is encrypted but cipher keys (user-specified or otherwise-generated) are not shared amongst nodes or agents to ensure privacy.

In a more limited form of this model, a central service could arrange exchanges between interested parties that already have an established level of trust. The technology would provide a turnkey solution for those parties, helping to deal with the data movement and storage logistics of the swap. Even among friendly parties, the reliability scoring may be useful to keep parties honest, and the technology would alleviate the headache of manually swapping files and tracking which files had been sent to the other party.

In some embodiments, a central service may be implement to store copy of a user's data assets for a particular period of time. In one of these embodiments, the central service may transmit the data assets to another node. In another of these embodiments, the central service transmits the data assets after an expiration of a period of time. In still another of these embodiments, the use of the central service to receive the data assets and re-transmit the data assets later eliminates the need for direct communication between nodes. “Partially on-line” Data Storage Applications

In some embodiments, the methods and systems described above are implemented in hardware. In other embodiments, the technology is implemented in software. In one of these embodiments, a model implements both the technology described above and Storage Area Network (SAN) technology. Many data storage applications do not strictly require instant access to information provided by SAN technology. As an example, consider a photo sharing web-site where a large number of high resolution images must be stored for ultimate print-making, however these high-resolution files are not normally displayed to the user on the order web-site or community review web-site. The user makes their ordering selection using a low-resolution proxy, and then during fulfillment and delivery the actual high resolution file is needed over the course of a few hours. In this model, the SAN is used to store data which is frequently accessed and the methods and systems described above provide cheap, redundant storage for a large set of data files that are infrequently accessed.

Data Movement

A number of industry applications involve the movement of information from one site to another, such as transferring digital files to a print shop. The technology, in its ability to generate data receipts, provides an effective and generalized architecture for data transfer and management of “logistics”.

Caching

In one embodiment, a web-site where a constantly updating series of digital assets (software, images, etc) must be served. The technology, in its ability to define general rules around data currency and asset management, could help maintain caches of locally available information to a web-server while in the background helping to maintain that cache. For instance, the technology could serve as the back-end to a network protocol that allows a software agent to request a file. The technology could then transfer the file locally and serve that file back to the requester, keeping a local copy. The generalized data logistics management provided is easily adapted to this use case since it automatically track the location and currency of information in the network.

The methods and systems described may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, LISP, PERL, C, C++, PROLOG, or any byte code language such as JAVA. The software programs may be stored on or in one or more articles of manufacture as object code.

Having described certain embodiments of the invention, it will now become apparent to one of skill in the art that other embodiments incorporating the concepts of the invention may be used. Therefore, the invention should not be limited to certain embodiments, but rather should be limited only by the spirit and scope of the following claims.

What is claimed is:

1. A method of providing data storage and retrieval, the method comprising the steps of:
(a) identifying an asset stored by a first resource;
(b) generating an asset record identifying the asset; and
(c) transmitting, to an agent associated with a second resource, at least one of:
(i) the generated asset record,
ii) metadata associated with the asset,
(iii) a description of a condition associated with the asset,
(iv) the generated asset record and metadata associated with the asset,
(v) the generated asset record and a description of a condition associated with the asset,
(vi) the asset and metadata associated with the asset,
(vii) the asset and a description of a condition associated with the asset,
(viii) metadata and a description of a condition associated with the asset, (ix) the generated asset record and the asset and a description of a condition associated with the asset, and
(x) the generated asset record and the asset and metadata associated with the asset.

2. The method of claim 1, wherein step (a) further comprises identifying a block of information.

3. (canceled)

4. The method of claim 1, wherein step (b) further comprises generating a distributed database record identifying the asset.

5. (canceled)

6. (canceled)

7. (canceled)

8. The method of claim 1 further comprising the step of consulting at least one receipt when determining whether a resource in the plurality of resources stores the copy of the asset.

9. (canceled)

10. (canceled)

11. The method of claim 1, wherein step (c) further comprises transmitting to the agent a request for an indication of acceptance of the described condition.

12. (canceled)

13. (canceled)

14. (canceled)

15. The method of claim 1, farther comprising the step of transmitting to an agent associated with a third resource, at least one of:
(i) the generated asset record,
(ii) metadata associated with the asset,
(iii) a description of a condition associated with the asset,
(iv) the generated asset record and metadata associated with the asset,
(v) the generated asset record and a description of a condition associated with the asset,
(vi) the asset and metadata associated with the asset,
(vii) the asset and a description of a condition associated with the asset,
(viii) metadata and a description of a condition associated with the asset,
(ix) the generated asset record and the asset and a description of a condition associated with the asset, and
(x) the generated asset record and the asset and metadata associated with the asset.

16. (canceled)

17. The method of claim 1 further comprising the step of satisfying the condition.

18. (canceled)

19. A system for providing data storage and retrieval comprising:
a means for identifying an asset stored by a first resource;
a means for generating an asset record identifying the asset;
a means for transmitting, to an agent associated with a second resource, at least one of:
(i) an asset record identifying an asset,
(ii) metadata associated with the asset,
(iii) a description of a condition associated with the asset,
(iv) the asset record and metadata associated with the asset,
(v) the asset record and a description of a condition associated with an asset,
(vi) the asset and metadata associated with the asset,
(vii) the asset and a description of a condition associated with the asset,
(viii) metadata and a description of a condition associated with the asset,
(ix) the asset record and the asset and a description of a condition associated with the asset, and
(x) the asset record and the asset and metadata associated with the asset.

20. The system of claim 19, wherein the means for identifying the asset further comprises a means for identifying a block of information.

21. (canceled)

22. The system of claim 19, further comprising a means for consulting at least one receipt when determining whether a resource in the plurality of resources stores the copy of the asset.

23. (canceled)

24. The system of claim 19 further comprising a means for consulting at least one rule when identifying the at least one resource in the plurality of resources.

25. The system of claim 19 further comprising a means for satisfying a condition associated with the asset.

26. A method of providing data storage and retrieval, the method comprising the steps of:
(a) receiving, from an agent associated with a resource, at least one of:
(i) an asset record identifying an asset,
(ii) metadata associated with the asset,
(iii) a description of a condition associated with the asset,
(iv) the asset record and metadata associated with the asset,
(v) the asset record and a description of a condition associated with the asset,
(vi) the asset and metadata associated with the asset.
(vii) the asset and a description of a condition associated with the asset,
(viii) metadata and a description of a condition associated with the asset,
(ix) the asset record and the asset and a description of a condition associated with the asset, and
(x) the asset record and the asset and metadata associated with the asset; and
(b) determining to satisfy a condition associated with the asset.

27. The method of claim 26, wherein step (b) further comprises receiving, from a second agent, the description of the condition associated with the asset.

28. (canceled)

29. The method of claim 26, wherein step (b) further comprises satisfying, by an agent associated with a second resource, the condition.

30. The method of claim 26, wherein step (b) further comprises incorporating the generated asset record into a database accessible by an agent associated with a second resource.

31. The method of claim 26, wherein step (b) further comprises storing the asset on a second resource.

32. The method of claim 26, wherein step (b) further comprises transmitting an indication of the existence of the asset on a second resource to the agent associated with the remote resource.

33. (canceled)

34. The method of claim 26, wherein step (b) further comprises storing the metadata on a second resource.

35. The method of claim 26, wherein step (b) further comprises accessing at least one rule to satisfy the condition.

36. The method of claim 26, wherein step (b) comprises determining not to satisfy the condition.

37. The method of claim 26, wherein step (b) further comprises generating a data structure identifying the asset, identifying a local resource, indicating whether the asset resides on the second resource, and identifying a condition associated with the asset.

38. (canceled)

39. The method of claim 37, wherein step (b) further comprises transmitting the data structure to a distributed data catalog.

40. A system for providing data storage and retrieval comprising:
a means for receiving, from an agent associated with a resource, at least one of:
(i) an asset record identifying an asset,
(ii) metadata associated with the asset,
(iii) a description of a condition associated with the asset,
(iv) the asset record and metadata associated with the asset,
(v) the asset record and a description of a condition associated with the asset,
(vi) the asset and metadata associated with the asset,
(vii) the asset and a description of a condition associated with the asset,
(viii) metadata and a description of a condition associated with the asset,
(ix) the asset record and the asset and a description of a condition associated with the asset, and
(x) the asset record and the asset and metadata associated with the asset; and
a means for determining to satisfy a condition associated with the asset.

41. The system of claim 40, wherein the means for satisfying the condition further comprises a means for storing the asset on at least one resource.

42. (canceled)

43. The system of claim 40, wherein the means for satisfying the condition further comprises a means for accessing at least one rule to satisfy the condition.

44. The system of claim 40, wherein the means for satisfying the condition further comprises a means for determining not to satisfy the condition.

45. The system of claim 40, wherein the means for satisfying the condition further comprises a means for receiving a description of the condition associated with the asset from a second agent.

46. (canceled)

47. (canceled)

48. (canceled)

49. (canceled)

50. (canceled)

51. (canceled)

52. (canceled)

53. (canceled)

54. A method of providing data storage and retrieval, the method comprising the steps of:
(a) accessing a data structure identifying an asset, identifying a resource associated with the asset, and identifying a condition associated with the asset;
(b) consulting at least one rule associated with the asset; and
(c) satisfying the condition.

55. The method of claim 54, wherein step (b) further comprises satisfying a condition identified by the at least one rule.

56. The method of claim 54, wherein step (c) further comprises application of the at least one rule to the condition.

57. The method of claim 54, wherein step (c) further comprises determining not to satisfy the condition.

58. A system for providing data storage and retrieval comprising:
a means for accessing a data structure identifying an asset, identifying a resource associated with the asset, and identifying a condition associated with the asset;
a means for consulting at least one rule associated with the asset; and
a means for satisfying the condition.

59. The system of claim 58, wherein the means for consulting at least one rule further comprises a means for satisfying a condition identified by the at least one rule,

60. The system of claim 58, wherein the means for satisfying the condition further comprises a means for applying the at least one rule to the condition.

61. The system of claim 58, wherein the means for satisfying the condition further comprises a means for determining not to satisfy the condition.

62. A method of providing data storage and retrieval, the method comprising the steps of:
(a) receiving, from an agent associated with a first resource, at least one of:
(i) an asset record identifying an asset,
(ii) metadata associated with the asset
(iii) the description of a condition associated with the asset,
(iv) the asset record and metadata associated with the asset,
(v) the asset record and a description of a condition associated with the asset,
(vi) the asset and metadata associated with the asset,
(vii) the asset and a description of a condition associated with the asset,
(viii) metadata and a description of a condition associated with the asset,
(ix) the asset record and the asset and a description of a condition associated with the asset, and
(x) the asset record and the asset and metadata associated with the asset;
(b) determining to satisfy a condition associated with the asset; and
(c) transmitting a data structure, the data structure:
(i) identifying the asset,
(ii) identifying a second resource, and
(iii) indicating whether the asset resides on a second resource.

63. The method of claim 62, wherein step (c) further comprises transmitting a data structure including a condition associated with the asset.

64. (canceled)

65. The method of claim 62, wherein step (c) further comprises transmitting a data structure including metadata, the metadata identifying a time of verification of the existence of the asset on the local resource.

66. The method of claim 62, wherein step (c) further comprises transmitting a data structure including metadata, the metadata identifying a manner of verification of the existence of the asset on the local resource.

67. The method of claim 62, wherein step (a) further comprises receiving, from an agent associated with the second resource, at least one of:
(i) an asset record identifying an asset,
(ii) metadata associated with the asset,
(iii) a description of a condition associated with the asset,
(iv) the asset record and metadata associated with the asset,
(v) the asset record and a description of a condition associated with the asset,
(vi) the asset and metadata associated with the asset,
(vii) the asset and a description of a condition associated with the asset,
(viii) metadata and a description of a condition associated with the asset,
(ix) the asset record and the asset and a description of a condition associated with the asset, and
(x) the asset record and the asset and metadata associated with the asset.

68. A system for providing data storage and retrieval comprising:
a means for receiving, from an agent associated with a first resource, at least one of:
(i) an asset record identifying an asset,
(ii) metadata associated with the asset,
(iii) the description of a condition associated with the asset,
(iv) the asset record and metadata associated with the asset,
(v) the asset record and a description of a condition associated with the asset,
(vi) the asset and metadata associated with the asset,
(vii) the asset and a description of a condition associated with the asset,
(viii) metadata and a description of a condition associated with the asset,
(ix) the asset record and the asset and a description of a condition associated with the asset, and
(x) the asset record and the asset and metadata associated with the asset;
a means for determining to satisfy a condition associated with the asset; and
a means for transmitting a data structure, the data structure:
(i) identifying the asset,
(ii) identifying a second resource, and
(iii) indicating whether the asset resides on a second resource.

69. (canceled)

70. The system of claim 68, wherein the means for transmitting the data structure further comprises a means for transmitting a data structure including a condition associated with the asset.

71. The system of claim 68, wherein the means fox transmitting a data structure further comprises a means for generating the data structure.

72. (canceled)

73. (canceled)

74. The method of claim 54, wherein step (a) further comprises accessing a data structure identifying a resource on which the asset resides.

75. The system of claim 58, wherein the means for accessing further comprises a means for accessing a data structure identifying a resource on which the asset resides.
